(19) United States
(12) Patent Application Publication
(10) Pub. No.: US 2004/0257973 A1
(43) Pub. Date: Dec. 23, 2004

(54) Optical data medium containing; in the information layer, a dye as a light-absorbing compound

(76) Inventors: Horst Berneth, Leverkusen (DE); Friedrich-Karl Bruder, Krefeld (DE); Yuichi Sabi, Tokyo (JP); Masanobu Yamamoto, Tokyo (JP); Wilfried Haese, Odenthal (DE); Karin Hassenruck, Dusseldorf (DE); Serguei Kostromine, Swisttal (DE); Peter Landenberger, Koln (DE); Thomas Sommermann, Gladbach (DE); Josef-Walter Stawitz, Odenthal (DE); Rainer Hagen, Leverkusen (DE); Rafael Oser, Krefeld (DE); Christa-Maria Kruger, Munster (DE); Timo Meyer-Friedrichsen, Krefeld (DE); Sakuya Tamada, Tokyo (JP)

Correspondence Address: Bayer Chemicals Corporation, Patent Deparment, 100 Bayer Road, Pittsburgh, PA, 15205-9741, US

(21) Appl. No.: 10/491,755

(22) PCT Filed: Sep. 27, 2002
(86) PCT No.: PCT/EP02/10900

(30) Foreign Application Priority Data
Oct. 4, 2001 (EP) 01123810.2
Dec. 21, 2001 (EP) 01130527.3
Mar. 11, 2002 (EP) 02005505.9

(51) Int. Cl. G11B 7/24

(52) U.S. Cl. 369/275.5; 369/288

(57) ABSTRACT

Optical data medium containing in the information layer, a dye as a light-absorbing compound Abstract optical data medium containing a preferably transparent substrate which is optionally already coated with one or more barrier layers and on the surface of which an information layer which can be recorded on using light, optionally one or more barrier layers, and a cover layer containing a radiation-cured resin, have been applied, which data medium can he recorded on and read using focused blue light through the cover layer on the information layer, preferably laser light with the wavelength between 360 nm and 460 nm, the information layer containing a light-absorbing characterized in that at least one dye is used as the light-absorbing compound wherein the cover layer dies have a total thickness of 10 μm 177 m and the numerical aperture NA of the focusing objective lens setup is greater or equal 0.8.

### PRIOR ART

The invention relates to a, preferably singly recordable, optical data medium which contains, in the information layer, at least one dye as a light-absorbing compound, and has a defined thickness of all the cover layers and can be recorded and readout with a focusing optical setup with a defined numerical aperture and a process for its production.

The singly recordable optical data media using special light-absorbing substances or mixtures thereof are suitable in particular for use in the case of high-density recordable optical data media which operate with blue laser diodes, in particular GaN or SHG laser diodes (360-460 nm) and/or for use in the case of DVD-R or CD-R discs which operate with red (635-660 nm) or infrared (760-830 nm) laser diodes, and the application of the abovementioned dyes to a polymer substrate, made from for example polycarbonates, copolycarbonates, polycycloolefines, polyolefines, by spin-coating, vapour deposition or sputtering.

The singly recordable compact disc (CD-R, 780 nm) has recently been experiencing enormous growth in quantity and is a technically established system.

Recently, the next generation of optical data stores—the DVD—was launched on the market. By using shorter-wave laser radiation (635 to 660 nm) and a higher numerical aperture NA, the storage density can be increased. In this case, the singly recordable format is the DVD-R.

Optical data storage formats which use blue laser diodes (based on GaN, JP-A-0S 191 171 or Second Harmonic Generation SHG JP-A-09 050 629) (360 nm to 460 nm) having a high laser power are now being developed. Recordable optical data stores are therefore also used in this generation. The recordable storage density depends on the focusing of the laser spot in the information plane. The spot size is scaled with the laser wavelength λ/NA. NA is the numerical aperture of the lens used. In order to obtain as high a storage density as possible, the use of as short a wavelength λ as possible is desirable. At present, 390 nm are possible oil the basis of semiconductor laser diodes.

The patent literature describes recordable optical data stores which are based on dyes and are just as suitable for CD-R and DVD-R systems (JP-A 11 043 481 and JP-A 10 181 206). Here, for high reflectivity and a high modulation amplitude of the read-out signal, and for sufficient sensitivity during recording, use is made of the fact that the IR wavelength 780 nm of the CD-R lies at the foot of the long-wave flank of the absorption peak of the dye, and the red wavelength 635 nm or 650 nm of the DVD-R also lies at the foot of the long-wave flank of the absorption peak of the dye. This concept is extended to include the region of 450 nm operating wavelength on the short-wave flank of the absorption peak.

In addition to the abovementioned optical properties, the recordable information layer comprising light-absorbing organic substances must have a morphology which is as amorphous as possible, in order to minimize the noise signal during recording and read-out. For this purpose, it is particularly preferred if, during application of the substances by spin-coating from a solution, by sputtering or by vapour deposition and/or sublimation, crystallization of the light-absorbing substances is prevented during the subsequent overcoating with metallic or dielectric layers in vacuo.

The amorphous layer of light-absorbing substances should preferably have a high heat distortion resistance, since otherwise further layers of organic or inorganic material which are applied by sputtering or vapour deposition to the light-absorbing information layer will form ill-defined interfaces through diffusion and thus adversely affect the reflectivity. In addition, light-absorbing substances having too low a heat distortion resistance at the interface with a polymeric substrate can diffuse into the latter and once again adversely affect the reflectivity.

If a light-absorbing substance has a too high vapour pressure, said substance can sublime during the abovementioned sputtering or vapour deposition of further layers in a high vacuum and hence reduce the desired layer thickness. This in turn leads to an adverse effect on the reflectivity.

Upon comprising a high Ar, lens as an objective lens in purpose to achieve as high areal density as possible, the thickness of transparent layer, which a readout beam transmit through when focusing on the information layer, namely the substrate or cover layer, will restrict its skew margin. Since the NA of CD and DVD objective lens are 0.45 and 0.60 respectively, their substrate thickness were chosen as 1.2 mm and 0.6 mm respectively to assure its sufficient skew margin for mass productive optical drives. The thickness of the cover layer is of significant importance for mass production since the production process will be totally different from the conventional medium, and accordingly the recording/readout performance of the medium should also be optimised for such newly designed medium. Since such thin cover layer will be easily bent and thus it is not appropriate to coat the information layer directly on the cover, the information layer and protective layer will be formed on a thick substrate before the cover layer is fixed on the substrate. CD-R and DVD-R utilize a UV resin hard cover both on purpose for the protective layer and also to cover the information layer with sufficient hardness to improve its recording properties(JP-A 2834420).

It is accordingly an object of the invention to provide suitable compounds which meet the high requirements (such as light stability, advantageous signal/noise ratio, damage-free application to the substrate material, etc.) for use in the information layer in a singly recordable optical data medium, in particular for high-density recordable optical data storage formats in a laser wavelength range of from 360 to 460 nm.

Surprisingly, it was found that light-absorbing compounds from the group consisting of dyes in combination with special parameters of the cover layer thickness accompanied with the NA, preferably phthalocyanine dyes can fulfill the abovementioned requirement profile particularly well. Especially Phthalocyanines have an intense absorption in the wavelength range of 360-460 nm important for the laser, i.e. the B or Soret band.

The present invention therefore relates to an optical data medium, containing a preferably transparent substrate which is optionally already coated with one or more barrier layers and on the surface of which an information layer which can be recorded on using light, optionally one or more barrier layers and a cover layer, containing a radiation-cured resin, have been applied, which can be recorded on and read using focused blue light through the cover layer on the information layer, preferably laser light, particularly preferably light at 360-460 nm, in particular 380-440 nm, very particularly preferably at 395-415 nm, the information layer containing a light-absorbing compound and optionally a binder, characterized in that at least one dye is used as the light-absorbing compound wherein the cover layer does have a total thickness of 10 μm to 177 μm and the numerical aperture NA of the focusing objective lens setup is greater or equal 0.8 preferable 0.80 to 0.95.

Preferred are merocyanines as light-absorbing compound, most preferably corn-pounds of the formula

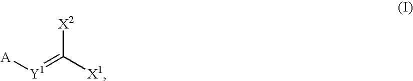

are preferred, wherein

A represents a radical of the formula

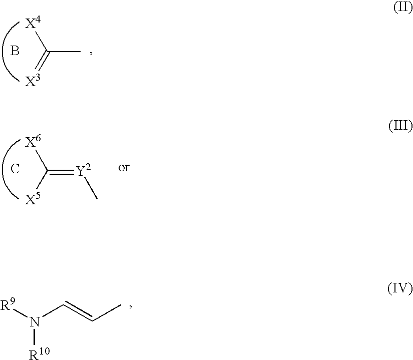

X¹ represents CN, CO—R¹, COO—R², CONHR³ or CONR³R⁴,

X² represents hydrogen, C₁- to C₆-alkyl, C₆- to C₁₀-aryl, a five- or six-membered heterocyclic radical, CN, CO—R¹, COO—R², CONHR³ or CONR³R⁴ or

CX¹X² represents a ring of the formulae

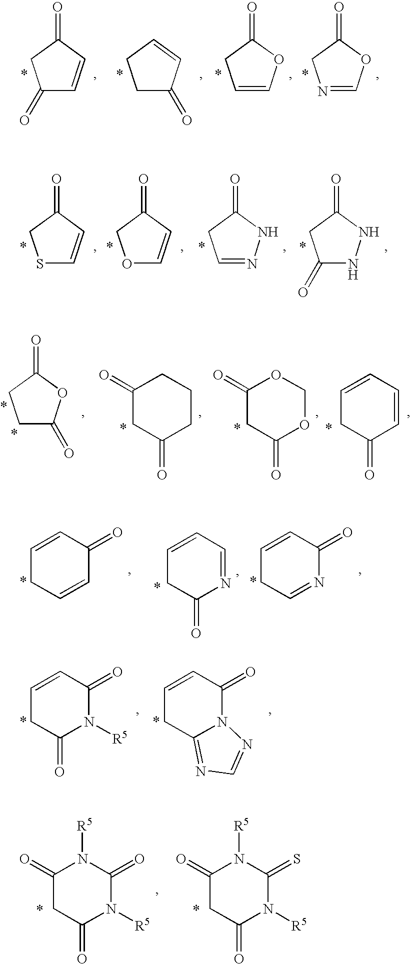

which can be benzo- or naphtha-fused and/or substituted by non-ionic or ionic radicals and wherein the asterisk (*) indicates the ring atom from which the double bond emanates,

X³ represents N or CH,

X⁴ represents O, S, N, N—R⁶ or CH, wherein X³ and X⁴ do not simultaneously represent CH,

X⁵ represents O, S or N—R⁶,

X⁶ represents O, S, N, N—R⁶, CH or CH₂,

the ring B of the formula (II)

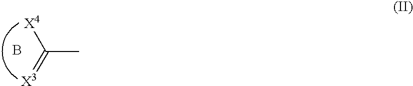

together with X⁴, X³ and the C atom bound there-between

and the ring C of the formula (V)

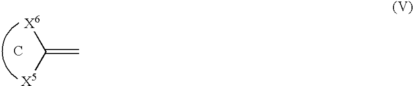

together with X⁵, X⁶ and the C atom bound there-between independently of one another represent a five- or six-membered aromatic or quasi-aromatic heterocyclic ring which can contain 1 to 4 hetero atoms and/or can be benzo- or naphtha-fused and/or substituted by non-ionic or ionic radicals,

Y¹ represents N or C—R⁷,

Y² represents N or C—R⁸,

R¹ to R⁶ independently of one another represent hydrogen, C₁ to C₆-alkyl, C₃ to C₆-alkenyl, C₅ to C₇-cycloalkyl, C₆- to C₁₀-aryl or C₇ to C₁₅-aralkyl

R⁷ and R⁸ independently of one another represent hydrogen, cyano or C₁ to C₆-alkyl,

R⁹ and R¹⁰ independently of one another represent C₁ to C₆-alkyl, C₆ to C₁₀-aryl or C₇ to C₁₅-aralkyl or

NR⁹R¹⁰ represents a 5- or 6-membered saturated heterocyclic ring.

Oligomeric and polymeric merocyanine dyes of the formula (I) are also preferred in which at least one of the radicals R¹ to R¹⁰ or at least one of the non-ionic radicals represent a bridge. This bridge can link two or more merocyanine dyes to form oligomers or polymers. It can however also represent a bridge to a polymeric chain. In this case the merocyanine dyes are bonded in a comb-like fashion to such a chain.

Suitable bridges are for example those of the formulae —(CH₂)ₙ— or —(CH₂)ₘ-Z-(CH₂)ₚ—,

wherein

n and m independently of each other represent an integer from 1 to 20 and

z represents —O— or —C₆H₄—.

Polymeric chains are for example polyacrylates, polymethacrylates, polyacrylamides, polymethacrylamides, polysiloxanes, poly-α-oxiranes, polyethers, polyamides, polyurethanes, polyureas, polyesters, polycarbonates, polystyrene or polymaleic acid.

Suitable non-ionic radicals are for example C₁ to C₄-alkyl, C₁ to C₄-alkoxy, halogen, cyano, nitro, C₁ to C₄-alkoxycarbonyl, C₁ to C₄-alkylthio, C₁- to C₄-alkanoylamino, benzoylamino, mono- or di-C₁ to C₄-alkylamino, pyrrolidino, piperidino, piperazino or morpholino.

Suitable ionic radicals are for example ammonium radicals or COO— or SO₃— radicals which can be bonded via a direct bond or via —(CH₂)ₙ—, wherein n represents an integer from 1 to 6.

Alkyl, alkoxy, aryl and heterocyclic radicals can optionally contain other radicals such as alkyl, halogen, nitro, cyano, CO—NH₂, alkoxy, trialkylsilyl, trialklylsiloxy or phenyl, the alkyl and alkoxy radicals can be straight-chained or branched, the alkyl radicals can be partially halogenated or perhalogenated, the alkyl and alkoxy radicals can be ethoxylated or propoxylated or silylated, adjacent alkyl and/or alkoxy radicals on aryl or heterocyclic radicals can together form a three- or four-membered bridge and the heterocyclic radicals can be benzo-fused and/or quaternized.

Particularly preferably

the ring B of the formula (II) represents furan-2-yl, thiophen-2-yl, pyrrol-2-yl, benzofuran-2-yl, benzothiophen-2-yl, thiazol-5-yl, imidazol-5 -yl, 1,3,4-thiadiazol-2-yl, 1,3,4-triazol-2-yl, 2- or 4-pyridyl, 2- or 4-quinolyl, wherein the individual rings can be substituted by C₁ to C₆-alkyl, C₁ to C₆-alkoxy, fluorine, chlorine, bromine, iodine, cyano, nitro, C₁ to C₆-alkoxycarbonyl, C₁- to C₆-alkylthio, C₁ to C₆-acylamino, C₆ to C₁₀-aryl, C₆ to C₁₀-aryloxy, C₆ to C₁₀-arylcarbonylamino, mono- or di-C₁ to C₆-alkylamino, N—C₁ to C₆-alkyl-N—C₆ to C₁₀-arylamino, pyrrolidino, morpholino or piperidino and

the ring C of the formula (V) represents benzothiazol-2-ylidene, benzoxazol-2-yl-idene, benzimidazol-2-ylidene, thiazol-2-ylidene, isothiazol-3-ylidene, isoxazol-3-ylidene, imidazol-2-ylidene, pyrazol-5-ylidene, 1,3,4-thiadiazol-2-ylidene, 1,3,4-oxadiazol-2-ylidene, 1,2,4-thiadiazol-5-ylidene, 1,3,4-triazol-2-ylidene, 3H-indol-2-ylidene, dihydropyridin-2- or -4-ylidene, or dihydro-quinolin-2- or -4-ylidene, wherein the individual rings can be substituted by C₁ to C₆-alkyl, C₁ to C₆-alkoxy, fluorine, chlorine, bromine, iodine, cyano, nitro, C₁ to C₆-alkoxycarbonyl, C₁ to C₆-alkylthio, C₁ to C₆-acylamino, C₆ to C₁₀-aryl, C₆- to C₁₀-aryloxy, C₆ to C₁₀-arylcarbonylamino, mono- or di-C₁ to C₆-alkylamino, N—C₁ to C₆-alkyl-N—C₆ to C₁₀-arylamino, pyrrolidino, morpholino or piperidino.

In a particularly preferred form the merocyanines used are those of the formula (VI)

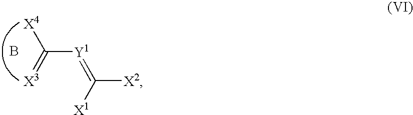

wherein

X¹ represents CN, CO—R¹ or COO—R²,

X² represents hydrogen, methyl, ethyl, phenyl, 2- or 4-pyridyl, thiazol-2yl, benzothiazol-2-yl, benzoxazol-2-yl, CN, CO—R¹ or COO—R², or

CX¹X² represents a ring of the formulae

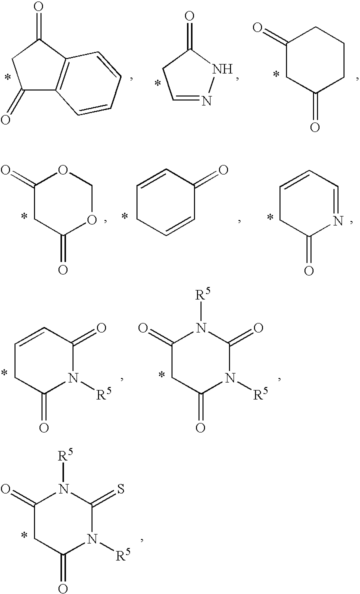

which can be substituted by up to 3 radicals from the group comprising methyl, ethyl, methoxy, ethoxy, fluorine, chlorine, bromine, cyano, nitro, methoxycarbonyl, ethoxycarbonyl, phenyl,

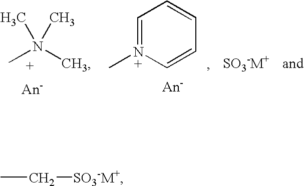

and wherein the asterisk (*) indicates the ring atom from which the double bond emanates,

An⁻ represents an anion,

M⁺ represents a cation,

X³ represents CH,

X⁴ represents O, S or N—R⁶,

the ring B of the formula (II) represents furan-2-yl, thiophen-2-yl, pyrrol-2-yl or thiazol-5-yl, wherein the above-mentioned rings can each be substituted by methyl, ethyl, propyl, butyl, methoxy, ethoxy, fluorine, chlorine, bromine, cyano, nitro, methoxycarbonyl, ethoxycarbonyl, methylthio, ethylthio, dimethylamino, diethylamino, dipropylamino, dibutylamino, N-methyl-N-phenylamino, pyrrolidino or morpholino,

Y¹ represents N or C—R⁷,

R¹, R², R⁵ and R⁶ independently of one another represent hydrogen, methyl, ethyl, propyl, butyl, pentyl, hexyl, phenyl or benzyl and

R⁵ additionally represents —(CH₂)₃—N(CH₃)₂ or CH₂)₃—N⁺(CH₃)₃ An⁻ and

R⁷ represents hydrogen or cyano.

In a form also particularly preferred the merocyanines used are those of the formula (VII)

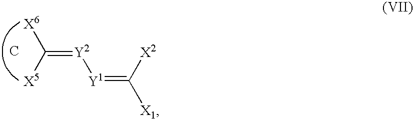

in which

X¹ represents CN, CO—R¹ or COO—R²,

X² represents hydrogen, methyl, ethyl, phenyl, 2- or 4-pyridyl, thiazol-2yl, benzothiazol-2-yl, benzoxazol-2-yl, CN, CO—R¹ or COO—R², or

CX¹ X² represents a ring of the formulae

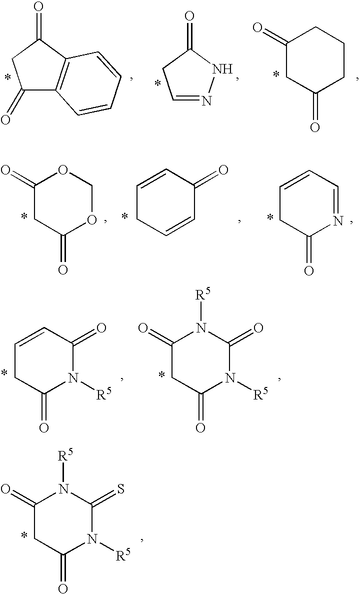

which can be substituted by up to 3 radicals from the group comprising methyl, ethyl, methoxy, ethoxy, fluorine, chlor, bromine, cyano, nitro, methoxycarbonyl, ethoxycarbonyl, phenyl,

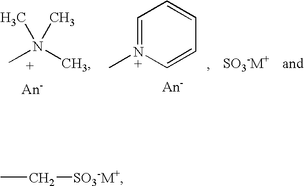

and wherein the asterisk (*) indicates the ring atom from which the double bond emanates,

An⁻ represents an anion,

M⁺ represents a cation,

X⁵ represents N—R⁶,

X⁶ represents S, N—R⁶ or CH₂,

the ring C of the formula (IV) represents benzothiazol-2-ylidene, benzimidazol-2-ylidene, thiazol-2-ylidene, 1,3,4-thiadiazol-2-ylidene, 1,3,4-triazol-2-ylidene, dihydropyridin-4-ylidene, dihydroquinolin-4-ylidene or 3H-indol-2-ylidene, wherein the above-mentioned rings can each be substituted by methyl, ethyl, propyl, butyl, methoxy, ethoxy, fluorine, chlorine, bromine, cyano, nitro, methoxycarbonyl, ethoxycarbonyl, methylthio, ethylthio, dimethylamino, diethylamino, dipropylamino, dibutylamino, N-methyl-N-phenylamino, pyrrolidino or morpholino,

Y²Y¹ represents N—N or (C—R⁸)—(C—R⁷),

R¹, R², R⁵ and R⁶ independently of one another represent hydrogen, methyl, ethyl, propyl, butyl, pentyl, hexyl, phenyl or benzyl and

R⁵ additionally represents —(CH₂)₃—N(CH₃)₂ or —(CH₂)₃—N⁺(CH₃)₃ An⁻ and

R⁷ and R⁸ represent hydrogen.

In a form also particularly preferred the merocyanines used are those of the formula (VIII)

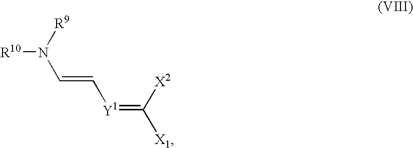

wherein

X¹ represents CN, CO—R¹ or COO—R²,

X² represents hydrogen, methyl, ethyl, phenyl, 2- or 4-pyridyl, thiazol-2yl, benzothiazol-2-yl, benzoxazol-2-yl, CN, CO—R¹ or COO—R², or

CX¹X² represents a ring of the formulae

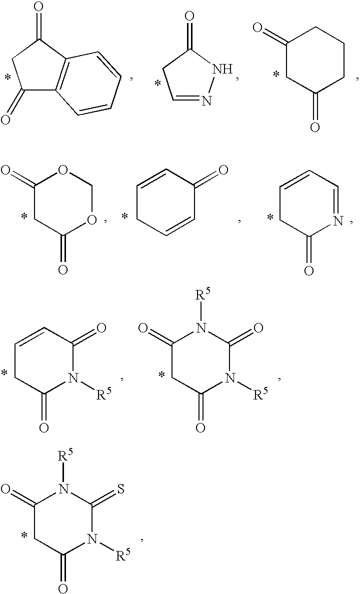

which can be substituted by up to 3 radicals from the group comprising methyl, ethyl, methoxy, ethoxy, fluorine, chlorine, bromine, cyano, nitro, methoxycarbonyl, ethoxycarbonyl, phenyl,

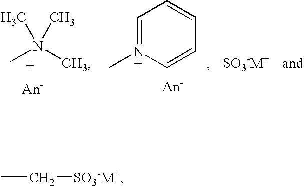

and wherein the asterisk (*) indicates the ring atom from which the double bond emanates,

An⁻ represents an anion,

M³⁰ represents a cation,

NR⁹R¹⁰ represents dimethylamino, diethylamino, dipropylamino, dibutylamino, N-methyl-N-phenylamino, pyrrolidino or morpholino,

Y¹ represents N or C—R⁷,

R¹, R² and R⁵ independently of one another represent hydrogen, methyl, ethyl, propyl, butyl, pentyl, hexyl, phenyl or benzyl and

R⁵ additionally represents —(CH₂)₃—N(CH₃)₂ or (CH₂)₃—N⁺(CH₃)₃ An⁻.

Suitable anions An⁻ are all monovalent anions or one equivalent of a polyvalent anion. Preferably the anions are colourless. Suitable anions are for example chloride, bromide, iodide, tetrafluoroborate, perchlorate, hexafluorosilicate, hexafluoro-phosphate, methosulphate, ethosulphate, C₁ to C₁₀-alkanesulphonate, C₁ to C₁₀-perfluoroalkanesulphonate, C₁ to C₁₀-alkanoate optionally substituted by chlorine, hydroxyl or C₁ to C₄-alkoxy, benzene sulphonate, naphthalene sulphonate or biphenyl sulphonate, which are optionally substituted by nitro, cyano, hydroxyl, C₁ to C₂₅-alkyl, perfluoro-C₁ to C₄-alkyl, C₁ to C₄-alkoxycarbonyl or chlorine, benzene disulphonate, naphthalene disulphonate or biphenyl disulphonate, which are optionally substituted by nitro, cyano, hydroxyl, C₁ to C₄-alkyl, C₁ to C₄-alkoxy, C₁- to C₄-alkoxycarbonyl or chlorine, benzoate which is optionally substituted by nitro, cyano, C₁ to C₄-alkyl, C₁ to C₄-alkoxy, C₁ to C₄-alkoxycarbonyl, benzoyl, chloro-benzoyl or toluoyl, the anion of naphthalenedicarboxylic acid, diphenyl ether disulphonate, tetraphenyl borate, cyanotriphenyl borate, tetra-C₁ to C₂₀-alkoxyborate, tetraphenoxyborate, 7,8- or 7,9-dicarba-nido-undecaborate(1) or (2), which are optionally substituted on the B and/or C atoms by one or two C₁ to C₁₂-alkyl or phenyl groups, dodecahydro-dicarbadodecaborate(2) or B—C₁ to C₁₂-alkyl-C-phenyl-dodecahydro-dicarbadodeca-borate(1).

Bromide, iodide, tetrafluoroborate, perchlorate, methane sulphonate, benzene sulphonate, toluene sulphonate, dodecylbenzene sulphonate and tetradecane sulphonate are preferred.

Suitable M⁺ cations are all monovalent cations or one equivalent of a polyvalent cation. The cations are preferably colourless. Suitable cations are for example lithium, sodium, potassium, tetramethyl ammonium, tetraethyl ammonium, tetrabutyl ammonium, trimethylbenzyl ammonium) trimethylcapryl ammonium or Fe(C₅H₅)₂⁺ (in which C₅H₅=cyclopentadienyl).

Tetramethyl ammonium, tetraethyl ammonium and tetrabutyl ammonium are preferred.

For a, preferably singly recordable, optical data carrier according to the invention which is written and read by light from a blue laser such merocyanine dyes are preferred whose absorption maximum λₘₐₓ₂ is in the range from 420 bis 550 nm, wherein the wavelength λ_{1/2} at which the extinction on the shortwave slope of the absorption maximum of the wavelength λₘₐₓ₂ is half the extinction value at λₘₐₓ₂ and the wavelength λ_{1/10} at which the extinction on the shortwave slope of the absorption maximum of the wavelength λₘₐₓ₂ is a tenth of the extinction value at λₘₐₓ₂, are preferably in each case no further than 50 nm away from each other. Preferably such a merocyanine dye does not display a shorter-wave maximum λₘₐₓ₁ at a wavelength below 350 nm, particularly preferably below 320 nm, and very particularly preferably below 290 nm.

Preferred merocyanine dyes are those with an absorption maximum λₘₐₓ₂ of 410 to 530 mn.

Particularly preferred merocyanine dyes are those with an absorption maximum λₘₐₓ₂ of420 to510 nm.

Very particularly preferred merocyanine dyes are those with an absorption maximum λₘₐₓ₂ of 430 to 500 nm.

Preferably λ_{1/2} and λ_{1/10}, as defined above, are no further than 40 nm, particularly preferably no further than 30 nm, and very particularly preferably no further than 20 nm away from each other in the merocyanine dyes.

The merocyanine dyes have a molar extinction coefficient ε of >40000 1/mol cm, preferably >60000 1/mol cm, particularly preferaby >80000 1/mol cm, and very particularly preferably >100000 1/mol cm at the absorption maximum λₘₐₓ₂.

The absorption spectra are measured for example in solution.

Suitable merocyanines having the required spectral properties are in particular those n min which the change in dipole moment Δμ=|μ_{g}−μ_{ag}|, i.e. the positive difference between the dipole moments in the ground state and in the first excited state, is as small as possible, preferably <5 D, and particularly preferably <2 D. One method of determining such a change in dipole moment Δμ is described for example in F. Würtlmer et al., Angew. Chem. 1997, 109, 2933 and in the literature cited therein. Low solvatochromism (dioxane/DMF) is also a suitable criterion for selection. Merocyanines are preferred whose solvatochromism Δλ=|λ_{DMF-λ}_{dioxane}|, ie. the positive difference between the absorption wavelengths in the solvents dimethylformamide and dioxane is <20 nm, particularly preferably <10 nm and very particularly preferably <5 nm.

Merocyanines which are very particularly preferred according to the invention are those of the formula

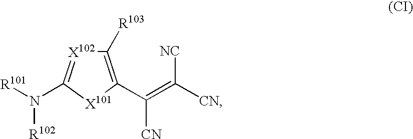

in which

X¹⁰¹ represents O or S,

X¹⁰² represents N or CR¹⁰⁴,

R¹⁰¹ and R¹⁰² independently of one another represent methyl, ethyl, propyl, butyl, pentyl, hexyl, cyclohexyl, benzyl or phenyl and R¹⁰¹ additionally represents hydrogen or

NR¹⁰¹CR¹⁰²′ represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰² and

R¹⁰⁴ represents hydrogen, methyl, ethyl, phenyl, chlorine, cyano, formyl or a radical of the formula

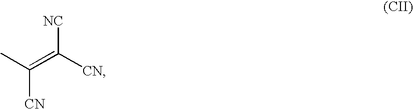

wherein the alkyl radicals such as propyl, butyl, etc. can be branched.

The attachment of a bridge for oligomeric or polymeric structures takes place via R¹⁰¹.

Merocyanines which are also very particularly preferred according to the invention are those of the formula

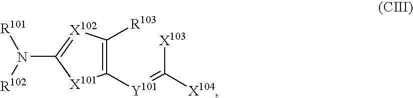

in which

X¹⁰¹ represents O or S,

X¹⁰² represents N or CR¹⁰⁴,

R¹⁰¹ and R¹⁰² independently of one another represent methyl, ethyl, propyl, butyl, pentyl, hexyl, cyclohexyl, benzyl or phenyl and R¹⁰¹ additionally represents hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

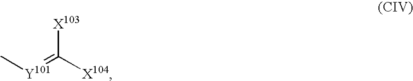

Y¹⁰¹ represents N or CH,

CX¹⁰³X¹⁰⁴ represents a ring of the formulae

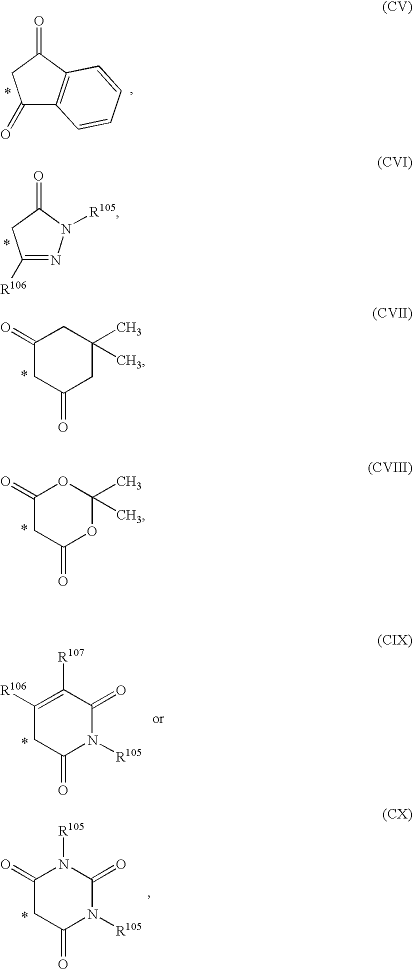

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

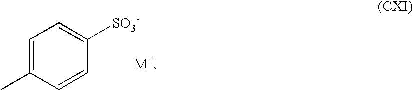

wherein in the case of the formula (CX) the two radicals R¹⁰⁵ can be different,

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃⁻M⁺ or a radical of the formulae

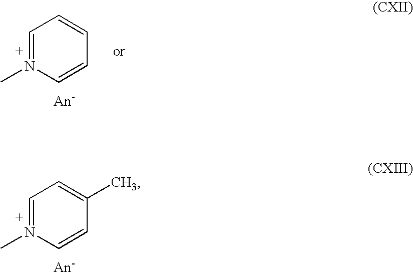

M⁺ represents a cation and

An⁻ represents an anion,

wherein the alkyl radicals such as propyl, butyl, etc. can be branched.

The attachment of a bridge for oligomeric or polymeric structures takes place via R¹⁰¹ or R¹⁰⁵.

Merocyanines which are also very particularly preferred according to the invention are those of the formula

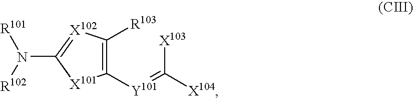

in which

X¹⁰¹ represents O or S,

X¹⁰² represents N or CR¹⁰⁴,

R¹⁰¹ and R¹⁰² independently of one another represent methyl, ethyl, propyl, butyl, pentyl, hexyl, cyclohexyl, benzyl or phenyl and R¹⁰¹ additionally represents hydrogen or

NR¹⁰¹R¹⁰² represents pyrrolidino, piperidino or morpholino,

R¹⁰³ represents hydrogen, methyl, ethyl, propyl, butyl, pentyl, hexyl, cyclohexyl, phenyl, tolyl, methoxyphenyl, thienyl, chlorine or NR¹⁰¹R¹⁰²,

R¹⁰⁴ represents hydrogen, methyl, ethyl, phenyl, chlorine, cyano, formyl or a radical of the formula

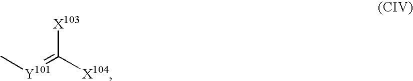

Y¹⁰¹ represents N or CH,

X¹⁰³ represents cyano, acetyl, methoxycarbonyl or ethoxycarbonyl and

X¹⁰⁴ represents 2-, 3- or 4-pyridyl, thiazol-2-yl, benzothiazol-2-yl, oxazol-2-yl, benzoxazol-2-yl, benzimidazol-2-yl, N-methyl- or N-ethyl-benzimidazol-2-yl,

wherein the alkyl radicals such as propyl, butyl, etc. can be branched.

The attachment of a bridge for oligomeric or polymeric structures takes place via R¹⁰¹ or X¹⁰³, if the latter represents an ester grouping.

Preferably, in the merocyanines of the formulae (CI) and (CIII)

R¹⁰³ represents hydrogen, methyl, i-propyl, tert-butyl or phenyl and

R¹⁰⁴ represents hydrogen or cyano.

Merocyanines which are also very particularly preferred according to the invention are those of the formula

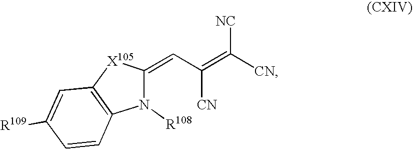

in which

X¹⁰⁵ represents S or CR¹¹⁰R¹¹¹,

R¹⁰⁸ represents methyl, ethyl, propyl, butyl, pentyl, hexyl, heptyl, octyl, methoxy-ethyl, methoxypropyl, cyanoethyl, hydroxyethyl, acetoxyethyl, chloro ethyl, cyclohexyl, benzyl or phenethyl,

R¹⁰⁹ represents hydrogen, methyl, ethyl, methoxy, ethoxy, cyano, chlorine, tri-fluoromethyl, trifluoromethoxy, methoxycarbonyl or ethoxycarbonyl,

R¹¹⁰ and R¹¹¹ independently of one another represent methyl or ethyl or

CR¹¹⁰R¹¹¹ represents a bivalent radical of the formula

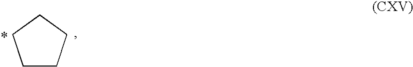

wherein two bonds emanate from the atom with an asterisk (*),

wherein the alkyl radicals such as propyl, butyl, etc. can be branched.

The attachment of a bridge for oligomeric or polymeric structures takes place via R¹⁰⁸.

Merocyanines which are also very particularly preferred according to the invention are those of the formula

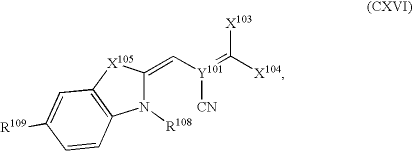

in which

X¹⁰⁵ represents S or CR¹¹⁰R¹¹¹,

R¹⁰⁸ represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, tri-fluoromethyl, trifluoromethoxy, methoxycarbonyl or ethoxycarbonyl,

R¹¹⁰ and R¹¹¹ independently of one another represent methyl or ethyl or

CR¹¹⁰R¹¹¹ represents a bivalent radical of the formula

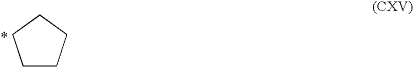

wherein two bonds emanate from the atom with an asterisk (*),

Y¹⁰¹ represents N or CH,

CX¹⁰³X¹⁰⁴ represents a ring of the formulae

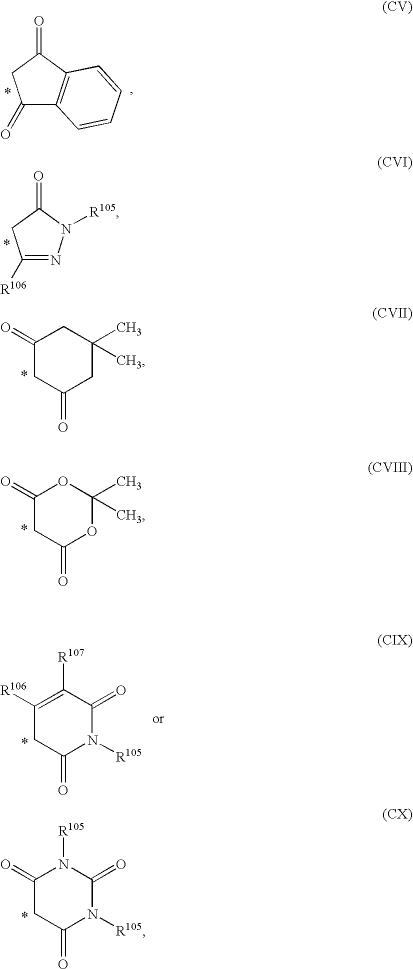

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

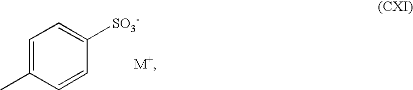

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃⁻M⁺ or a radical of the formulae

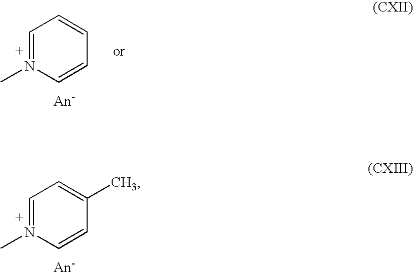

M⁺ represents a cation and

An⁻ represents an anion,

wherein the alkyl radicals such as propyl, butyl, etc. can be branched.

The attachment of a bridge for oligomeric or polymeric structures takes place via R¹⁰⁸ or R¹⁰⁵.

Merocyanines which are also very particularly preferred according to the invention are those of the formula

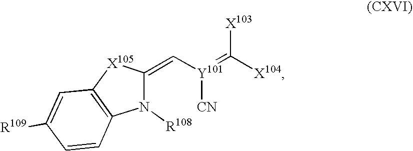

in which

X¹⁰⁵ represents S or CR¹¹⁰R¹¹¹,

R¹⁰⁸ represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹⁰⁹ represents hydrogen, methyl, ethyl, methoxy, ethoxy, cyano, chlorine, tri-fluoromethyl, trifluoromethoxy, methoxycarbonyl or ethoxycarbonyl,

R¹¹⁰ and R¹¹¹ independently of one another represent methyl or ethyl or

CR¹¹⁰R¹¹¹ represents a bivalent radical of the formula

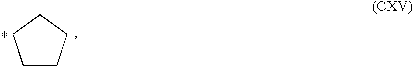

wherein two bonds emanate from the atom with an asterisk (*),

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-.2-yl, benzothiazol-2-yl, oxazol-2-yl, benzoxazol-2-yl, benzimidazol-2-yl, N-methyl- or N-ethyl-benzimidazol-2yl, preferably 2-pyridyl,

wherein the alkyl radicals such as propyl, butyl, etc. can be branched.

The attachment of a bridge for oligomeric or polymeric structures takes place via R¹⁰⁸ or X¹⁰³, if the latter represents an ester grouping.

Merocyanines which are also very particularly preferred according to the invention are those of the formula

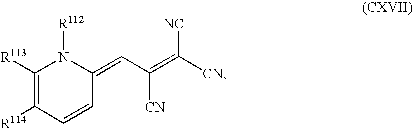

wherein

R¹¹² represents methyl, ethyl, propyl, butyl, pentyl, hexyl, heptyl, octyl, methoxy-ethyl, methoxypropyl, cyanloethyl, hydroxyethyl, acetoxyethyl, chloroethyl, cyclohexyl, benzyl or phenethyl,

R¹¹³ and R¹¹⁴ represent hydrogen or together represent a —CH═CH—CH═CH— bridge,

wherein the all radicals such as propyl, butyl etc. can be branched.

The attachment of a bridge for oligomeric or polymeric structures takes place via R¹¹².

Merocyanines which are also very particularly preferred according to the invention are those of the formula

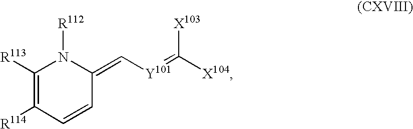

in which

R¹¹² represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or together represent a —CH═CH—CH═CH— bridge,

Y¹⁰¹ represents N or CH,

C¹⁰³X¹⁰⁴ represents a ring of the formulae

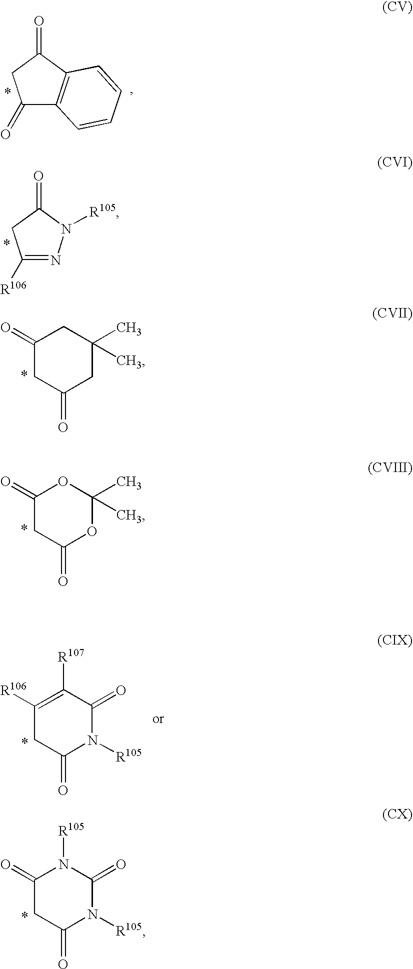

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

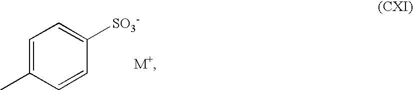

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃⁻M⁺ or a radical of the formulae

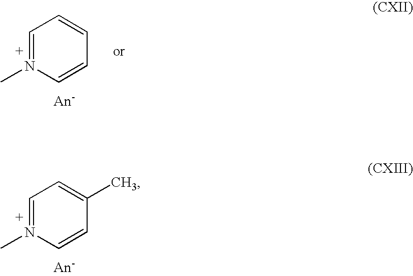

M⁺ represents a cation and

An⁻ represents an anion,

wherein the alkyl radicals such as propyl, butyl, etc. can be branched.

The attachment of a bridge for oligomeric or polymeric structures takes place via R¹¹² or R¹⁰⁵.

Merocyanines which are also very particularly preferred according to the invention are those of the formula

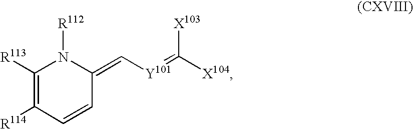

in which

R¹¹² represents methyl, ethyl, propyl, butyl, pentyl, hexyl, heptyl, octyl, methoxy-ethyl, methoxypropyl, cyanoethyl, hydroxyethyl, acetoxyethyl, chloroethyl, cyclohexyl, benzyl or phenethyl,

R¹¹³ and R¹¹⁴ represent hydrogen or jointly represent a —CH═CH—CH═CH— bridge,

Y¹⁰¹ represents N or CH,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methyl- or N-ethyl-benzimidazol-2-yl,

wherein the alkyl radicals such as propyl, butyl, etc. can be branched.

The attachment of a bridge for oligomeric or polymeric structures takes place via R¹¹² or X¹⁰³, if the latter represents an ester grouping.

Merocyanines which are also very particularly preferred according to the invention are those of the formula

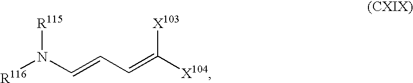

in which

R¹¹⁵ and R¹¹⁶ independently of one another represent methyl, ethyl, propyl, butyl, pentyl, hexyl1, heptyl, octyl, phenyl, benzyl or phenethyl or

NR¹¹⁵R¹¹⁶ represents pyrrolidino, piperidino or morpholino,

CX¹⁰³X¹⁰⁴ a ring of the formulae

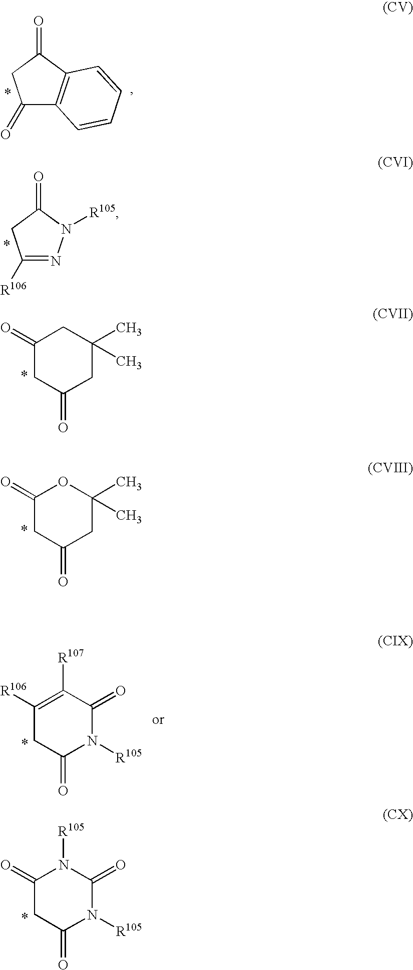

wherein the asterisk (*) indicates the ring atom from which the double bond emanates,

R¹⁰⁵ represents hydrogen, methyl, ethyl, propyl, butyl, pentyl, hexyl, heptyl, octyl, methoxyethyl, methoxypropyl, cyanoethyl, hydroxyethyl, acetoxyethyl, chloroethyl, cyclohexyl, phenyl, tolyl, methoxyphenyl or

a radical of the formula

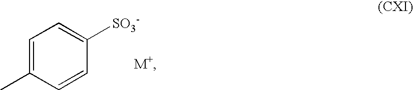

R¹⁰⁶ represents hydrogen, methyl, ethyl, propyl, butyl or trifluoromethyl,

R¹⁰⁷ represents cyano, methoxycarbonyl, ethoxycarbonyl, —CH₂SO₃⁻M⁺ or a radical of the formulae

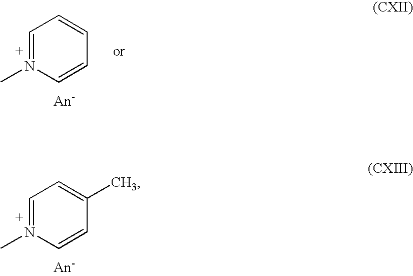

M⁺ represents a cation and

An⁻ represents an anion,

wherein the alkyl radicals such as propyl, butyl, etc. can be branched.

The attachment of a bridge for oligomeric or polymeric structures takes place via R¹¹⁵ or R¹⁰⁵.

Merocyanines which are also very particularly preferred according to the invention are those of the formula

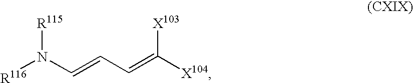

in which

R¹¹⁵ and R¹¹⁶ independently of one another represent methyl, ethyl, propyl, butyl, pentyl, hexyl, heptyl, octyl, phenyl, benzyl or phenethyl or

NR¹¹⁵R¹¹⁶ represents pyrrolidino, piperidino or morpholino,

X¹⁰³ represents cyano, acetyl, methoxycarbonyl or ethoxycarbonyl,

X¹⁰⁴ represents 2-, 3- or 4-pyridyl, thiazol-2-yl, benzothiazol-2-yl, oxazol-2-yl, benzoxazol-2-yl, benzimidazol-2-yl, N-methyl- or N-ethyl-benzimidazol-2-yl, preferably 2-pyridyl,

wherein the alkyl radicals such as propyl, butyl etc. can be branched.

The attachment of a bridge for oligomeric or polymeric structures takes place via R¹¹⁵ or X¹⁰³, if the latter represents an ester grouping.

In the formulae (CIII), (CXVI) and (CXVIII)

Y¹⁰¹ preferably represents CH and

in the formulae (CIII), (CXVI), (CXVIII) and (CXIX)

CX¹⁰³X¹⁰⁴ preferably represents a ring of the formulae (CV), (CVII) and (CIX) or a radical of the formulae

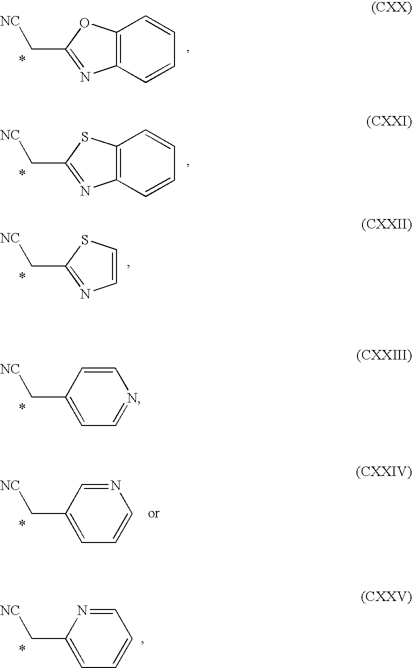

wherein the double bond emanates from the C atom with an asterisk (*).

—(CH₂)₂—, —(CH₂)₃—, —(CH₂)₄—, —(CH₂)₂—O—(CH₂)₂— and —CH₂—C₆H₄—CH₂— are preferred bridges.

Polyacrylate and polymethacrylate and copolymers thereof with acrylamides are preferred polymer chains. The abovementioned radicals R¹⁰¹, R¹⁰⁵, R¹⁰⁸, R¹¹² and R¹¹⁵ then for example represent a monomer unit of the formula

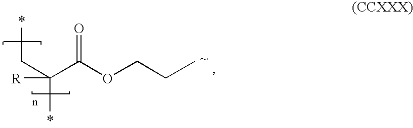

in which

R represents hydrogen or methyl

and a single bond to the N atom of the merocyanine dye emanates from the atom marked with a tilde (˜) and the atoms with an asterisk (*) represent the continuation of the chain.

Some of the merocyanines of the formula (I) are known, for example from F. Wüirthner, Synthesis 1999, 2103; F. Wüirthner, R. Sens, K.-H. Etzbach, G. Seybold, Angew. Chem. 1999, 111, 1753; DE-OS 43 44 116DE-OS 44 40 066; WO 98/23688; JP 52 99 379; JP 53 14 734.

Also preferred are phthalocyanines as light-absorbing compounds.

In a preferred embodiment, the phthalocyanine used is a compound of the formula (1)

MPc[R³]_{w}[R⁴]ₓ[R⁵]_{y}[R⁶]_{z} (1),

in which

Pc represents a phthalocyanine or a naphthocyanine, where in both cases the aromatic rings also may be heterocycles, for example tetrapyridinopor-phyrazines,

M represents two independent H atoms,,represent a divalent metal atom or represents a trivalent axially monosubstituted metal atom of the formula (1a)

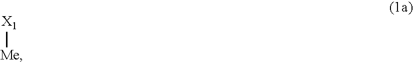

or represents a tetravalent axially disubstituted metal atom of the formula (1b)

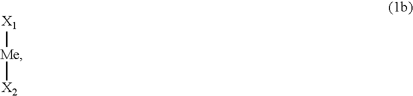

or represents a trivalent axially monosubstituted and axially monocoordinated metal atom of the formula (1c)

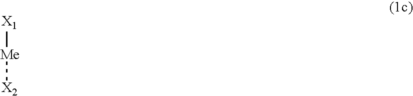

where, in the case of a charged ligand X₂ or X₁, the charge being compensated by an opposite ion, for example an anion An⁶³ or cation Kat^{⊕},

the radicals R³ to R⁶corresponding to substituents of the phthalocyanine ring, in which

X¹ and X², independently of one another, represent halogen as F, Cl, Br, I, hydroxyl, oxygen, cyano, thiocyanato, cyanato, alkenyl, alkinyl, arylthio, dialkylamino, alkyl, alkoxy, acyloxy, alkylthio, aryl, aryloxy, —O—SO₂_{R}⁸, —O—PR¹⁰OR¹¹, —O—P(O)R¹²R¹³, —O—SiR¹⁴R¹⁵R¹⁶, NH₂, alkylamino and the radical of a hetero-cyclic amine,

R³, R⁴, R⁵ and R⁶ independently of one another, represent halogen as F, Cl, Br, I, cyano, nitro, alkyl, aryl, alkylamino, dialkylamino, alkoxy, alkylthio, aryloxy, arylthio, SO₃H, SO₂NR¹R², CO₂R⁹, CONR¹R², NH—COR⁷ or a radical of the formula —(B)ₘ-D, in which

B denotes a bridge member from the group consisting of a direct bond, CH₂, CO, CH(alkyl), C(alkyl)₂, NH, S, O or —CH═CH—, (B)ₘ denoting a chemically reasonable sequence of bridge members B where m is from 1 to 10, preferably m is 1, 2, 3 or 4.

D represents the monovalent radical of a redox system of the formula

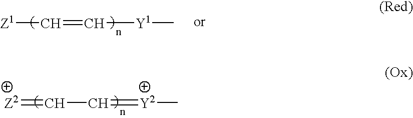

or represents a metallocenyl radical or metallocenylcarbonyl radical, titanium, manganese, iron, ruthenium or osmium being suitable as the metal centre,

Z¹ and Z², independently of one another, represent NR′R″, OR″ or SR″,

Y¹ represents NR′, O or S, Y² represents NR′,

n represents 1 to 10 and

R′ and R″, independently of one another, represent hydrogen, alkyl, cycloalkyl, aryl or hetaryl, or form a direct bond or bridge to one of the C atoms of the

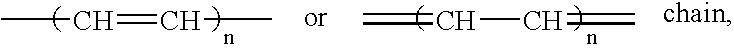

w, x, y and z, independently of one another, represent 0 to 4 and w+x+y+z≦16,

R¹ and R², independently of one another, represent hydrogen, alkyl, hydroxyalkyl, or aryl, or R¹ and R², together with the N atom to which they are bonded, form a heterocyclic 5-, 6- or 7-membered ring, optionally with participation of further hetero atoms, in particular from the group consisting of O, N and S, NR¹R² representing in particular pyrrolidino, piperidino or morpholino,

R⁷ to R¹⁶, independently of one another, represent alkyl, aryl, hetaryl or hydrogen, in particular represent alkyl, aryl or hetaryl,

An⁻ represents an anion, in particular represents halide, C₁- to C₂₀-alkylCOO-formate, oxalate, lactate, glycolate, citrate, CH₃OSO₃⁻, NH₂SO₃⁻, CH₃SO₃⁻, ½ SO₄²⁻ or ⅓ PO₄³⁻.

Where M represents a radical of the formula (1c), in particular with Co(III) as the metal atom, preferred heterocyclic amine ligands or substituents in the meaning of X¹ and X² are morpholine, piperidine, piperazine, pyridine, 2,2-bipyridine, 4,4-bipyridine, pyridazine, pyrimidine, pyrazine, imidazole, benzimidazole, isoxazole, benzisoxazole, oxazole, benzoxazole, thiazole, benzothiazole, quinoline, pyrrole, indole and 3,3-dimethylindole, each of which is coordinated with or substituted by the metal atom at the nitrogen atom.

The alkyl, alkoxy, aryl and heterocyclic radicals can optionally carry further radicals, such as alkyl, halogen, hydroxyl, hydroxyalkyl, amino, alkylamino, dialkylamino, nitro, cyano, CO—NH₂, alkoxy, alkoxycarbonyl, morpholino, piperidino, pyrrolidino, pyrrolidono, trialkylsilyl, trialkylsiloxy or phenyl. The alkyl and alkoxy radicals may be saturated, unsaturated, straight-chain or branched, the alkyl radical may be partly halogenated or perhalogenated and the alkyl and alkoxy radical may be ethoxylated, propoxylated or silylated. Neighbouring alkyl and/or alkoxy radicals on aryl or heterocyclic radicals may together form a three- or four-membered bridge.

Preferred compounds of the formula (1) are those in which the following applies for the radical R¹ to R¹⁶, R′ and R″ and for the ligands or substituents X¹ and X²:

substituents with the designation “alkyl” preferably denote C₁-C₁₆-alkyl, in particular C₁-C₁₆-alkyl, which are optionally substituted by halogen, such as chlorine, bromine or fluorine, hydroxyl, cyano and/or C₁-C₁₆-alkoxy;

substituents with the designation “alkoxy” preferably denote C₁-C₁₆-alkoxy, in particular C₁-C₁₆-alkoxy which are optionally substituted by halogen, such as chlorine, bromine or fluorine, hydroxyl, cyano and/or C₁-C₁₆-alkyl;

substituents with the designation “cycloalkyl” preferably denote C₄-C₈-cycloalkyl, in particular C₅- to C₆-cycloalkyl, which are optionally substituted by halogen, such as chlorine, bromine or fluorine, hydroxyl, cyano and/or C₁-C₆-alkyl.

substituents with the designation “alkenyl” preferably denote C₆-C₈-alkenyl which are optionally substituted by halogen, such as chlorine, bromine or fluorine, hydroxyl, cyano and/or C₁-C₆-alkyl, alkenyl denoting in particular allyl,

substituents with the meaning “hetaryl” preferably represent heterocyclic radicals having 5- to 7-membered rings which preferably contain hetero atoms from the group consisting of N, S and/or O and are optionally fused with aromatic rings or optionally carry further substituents, for example halogen, hydroxyl, cyano and/or alkyl, the following being particularly preferred: pyridyl, furyl, thienyl, oxazolyl, thiazolyl, imidazolyl, quinolyl, benzoxazolyl, benzothiazolyl and benzimidazolyl,

the substituents with the designation “aryl” are preferably C₆-C₁₀-aryl, in particular phenyl or naphthyl, which are optionally substituted by halogen, such as F or Cl, hydroxyl, C₁-C₆-alkyl, C₁-C₆-alkoxy, NO₂ and/or CN.

R³, R⁴, R⁵ and R⁶, independently of one another preferably represent chlorine, fluorine, bromine, iodine, cyano, methyl, ethyl, propyl, isopropyl, butyl, isobutyl, tert-butyl, pentyl, tert-amyl, hydroxyethyl, 3-dimethylaminopropyl, 3-diethylaminopropyl, phenyl, p-tert-butylphenyl, p-methoxyphenyl, iso-propylphenyl, trifluoromethylphenyl, naphthyl, methylamino, ethylamino, propylamino, isopropylamino, butylamino, isobutylamino, tert-butylamino, pentylamino, tert-amylamino, benzylamino, methylphenylhexylamino, hy-droxyethylamino, aminopropylamino, aminoethylamino, 3-dimethylamino-propylamino, 3-diethylaminopropylamino, diethylaminoethylamino, dibutyl-aminopropylamino, morpholinopropylamino, piperidinopropylamino, pyr-rolidinopropylamino, pyrrolidonopropylamino, 3-(methylhydroxyetlhyl-amino)propylamino, methoxyethylamino, ethoxyethylamino, methoxypropyl-amino, ethoxypropylamino, methoxyethoxypropylamino, 3-(2-ethylhexyl-oxy)propylamino, isopropyloxypropylamino, dimethylamino, diethylamino, ndiethanolamino, dipropylamino, diisopropylamino, dibutylamino, diiso-butylamino, di-tert-butylamino, dimethylamino, di-tert-amylamino, bis(2-ethylhexyl)amino, bis(aminopropyl)amino, bis(aminoethyl)amino, bis(3-dimethylaminopropyl)amino, bis(3-diethylaminopropyl)amino, bis(diethyl-aminoethyl)amino, bis(dibutylaminopropyl)amino, di(morpholinopropyl)-amino, di(piperidinopropyl)amino, di(pyrrolidinopropyl)amino, di(pyrrolidinopropyl)amino, bis(3-(methyl-hydroxyethylamino)propyl)amino, dimeth-oxyethylamino, diethoxyethylamino, dimethoxypropylamino, diethoxypro-pylamino, di(methoxyethoxyethyl)amino, di(methoxyethoxypropyl)amino, bis(3-(2-ethylhexyloxy)propyl)amino, di(isopropyloxyisopropyl)amino, methoxy, ethoxy, propyloxy, isopropyloxy, butyloxy, isobutyloxy, tert-butyl-oxy, pentyloxy, tert-amyloxy, methoxyethoxy, ethoxyethoxy, methoxy-propyloxy, ethoxypropyloxy, methoxyethoxypropyloxy, 3-(2-ethylhexyl-oxy)propyloxy, methylthio, ethylthio, propylthio, isopropylthio, butylthio, isobutylthio, tert-butylthio, pentylthio, tert-amylthio, phenyl, methoxyphenyl, trifluoromethylphenyl, naphthyl, CO₂R⁷, CONR¹R², NH—COR⁷, SO₃H, SO₂NR¹R² or preferably represent a radical of the formula

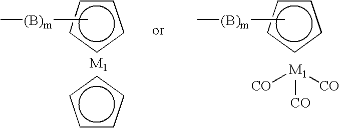

in which

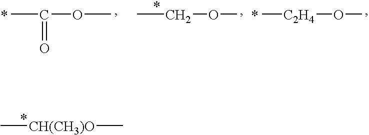

(B)ₘ represents

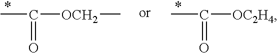

where the asterisk (*) indicates the link with the 5-membered ring,

M₁ represents an Mn or Fe cation,

w, x, y and z, independently of one another, represent 0 to 4 and w+x+y+z≦12,

NR¹R² preferably represent amino, methylamino, ethylamino, propylamino, isopro-pylamino, butylamino, isobutylamino, tert, butylamino, pentylamino, tert. amylamino, benzylamino, methylphenylhexylamino, 2-ethyl-1-hexylamino, hydroxyethylamino, aminopropylamino, aminoethylamino, 3-dimethylamino-propylamino, 3-diethylaminopropylamino, morpholinopropylamino, piperidi-nopropylamino, pyrrolidinopropylamino, pyrrolidonopropylamino, 3-(meth-yl-hydroxyethylamino)propylamino, methoxyethylamino, ethoxyethylamino, methoxypropylamino, ethoxypropylamino, methoxyethoxypropylamino, 3-(2-ethylhexyloxy)propylamino, isopropyloxyisopropylamino, dimethylamino, diethylamino, dipropylamino, diisopropylamino, dibutylamino, diiso-butylamino, di-tert-butylamino, dipentylamino, di-tert-amylamino, bis(2-ethylhexyl)amino, dihydroxyethylamino, bis(aminopropyl)amino, bis(amino-ethyl)amino, bis(3-dimethylaminopropyl)amino, bis(3-diethylaminopropyl)-amino, di(morpholinopropyl)amino, di(piperidinopropyl)amino, di(pyr-rolidinopropyl)amino, di(pyrrolidonopropyl)amino, bis(3-(methyl-hydroxy-ethylamino)propylamino, dimethoxyethylamino, diethoxyethylamino, di-methoxypropylamino, diethoxypropylamino, di(methoxyethoxypropyl)amino, bis(3-(2-ethylhexyloxy)propyl)amino, di(isopropyloxyisopropyl)amino, anilino, p-toluidino, p-tert-butylanilino, p-anisidino, isopropylanilino or naphtlamino or NR¹R² preferably represent pyrrolidino, piperidino, piperazino or morpholino,

R⁷ and R¹⁶, independently of one another preferably represent hydrogen, methyl, ethyl, propyl, isopropyl, butyl, isobutyl, tert-butyl, pentyl, tert-amyl, phenyl, p-tert-butylphenyl, p-methoxyphenyl, isopropylphenyl, p-trifluoromethyl-phenyl, cyanophenyl, naphthyl, 4-pyridyl, 2-pyridyl, 2-quinolinyl, 2-pyrrolyl or 2-indolyl,

it being possible for the alkyl, alkoxy, aryl and heterocyclic radicals optionally to carry further radicals, such as alkyl, halogen, hydroxyl, hydroxyalkyl, amino, alkyl-amino, dialkylamino, nitro, cyano, CO—NH₂, alkoxy, alkoxycarbonyl, morpholino, piperidino, pyrrolidino, pyrrolidono, trialkylsilyl, trialkylsilyloxy or phenyl, for the alkyl and/or alkoxy radicals to be saturated, unsaturated, straight-chain or branched., for the alkyl radicals to be partly halogenated or perhalogenated, for the alkyl and/or alkoxy radicals to be ethoxylated, propoxylated or silylated, and for neighbouring alkyl and/or alkoxy radicals on aryl or heterocyclic radicals together to form a three- or four-membered bridge.

In the context of this application, redox systems are understood as meaning in particular the redox systems described in Angew. Chem. 1978, page 927, and in Topics of Current Chemistry, Vol. 92, page 1 (1980).

p-Phenylenediamines, phenothiazines, dihydrophenazines, bipyridinium salts (viologens) and quinodimethanes are preferred.

In a preferred embodiment, phthalocyanines of the formula (1),

in which

M represents two independent H atoms or represents a divalent metal atom Me from the group consisting of Cu, Ni, Zn, Pd, Pt, Fe, Mn, Mg, Co, Ru, Ti, Be, Ca, Ba, Cd, Hg, Pb and Sn

or

M represents a trivalent axially monosubstituted metal atom of the formula (1a), in which the metal Me is selected from the group consisting of Al, Ga, Ti, In, Fe and Mn, or

M denotes a tetravalent axially disubstituted metal atom of the formula (1b), in which the metal Me is selected from the group consisting of Si, Ge, Sn, Zr, Cr, Ti, Co and V,

are used.

X¹ and X² are particularly preferably halogen, in particular chlorine, aryloxy, in particular phenoxy, or alkoxy, in particular methoxy.

R³- R⁶ represent in particular halogen, C₁-C₆-alkyl or C₁-C₈-alkoxy.

Phthalocyanines of the formula I in which M represents a radical of the formula (1a) or (1b) are very particular preferred. Very particular preferred w, x, y and z each represent 0. X¹ and/or X² in formula (1a) or (1b) each denote halogen in a very particularly preferred way.

The phthalocyanines used according to the invention can be prepared by known methods, for example:

by synthesis of the nucleus from correspondingly substituted phthalodinitriles in the presence of the corresponding metals, metal halides or metal oxides,

by chemical modification of a phthalocyanine, for example by sulpho-chlorination or chlorination of phthalocyanines and further reactions, for example condensations or substitutions of the products resulting therefrom,

the axial substituents X¹ and X² are usually prepared from the corresponding halides by exchange.

Additionally special dyes known from different patent applications identified below are possible as light-absorbing compound.

The following patent applications are incorporated by reference with respect to the definition of the respective dyes:

WO-A-01/75873 all cited dyes preferably (CI), (CHI), (CX), (CXII), (CCI), (CCIII), (CCIV), (CCV), (CCVIII), (CCIX), (CCXII), (CCXIII), (CCXIV), (CCXV), (CCXVIII), (CCCII), (CCCXI), (CCCXII), (CCCXIII) and (CDXIX).

PTC Application No. 02/03071 all cited dyes, preferably polymeric dyes of the formulae (CI) to (CXXI), (CCI) to (CCXXVI), (CCCIX), preferably formulae (CI), (CII), (CVI), (CVII), (CIX), (CXI), (CXII), (CXIII), (CXIV), (CCI), (CCIII), (CCIV), (CCV), (CCXVII), (CCXVIII), (CCXIX), (CCCIX).

PCT Application No. 02/03066 all cited dyes, preferably dyes of the formulae (V) to (XII).

PCT Application No. 02/03088 all cited dyes, preferably dyes of the formulae (IIIa), (IVa), (V) to (IX), particularly preferred formulae (V), (VII) to (IX).

PCT Application No. 02/03081 all cited dyes.

PCT Application No. 02/03070 all cited dyes, preferably dyes of the formulae (III), (IV) and (V).

PCT Application No. 02/03065 all cited dyes, preferably dyes of the formulae (IV) to (XII) and formulae (XIII) to (XXV), provided that for formulae (XIII) to (XXV) the substituent Y represents C—CN or N.

PCT Application No. 02/03086 all cited dyes, preferably dyes of the formulae (VIII), (XII) and (XIV) to (XVII).

The light-absorbing compound should preferably be thermally modifiable. Thermal modification is preferably effected at a temperature of <700° C. Such a modification may be, for example, decomposition, morphology change or chemical modification of the chromophoric centre of the light-absorbing compound.

The light-absorbing substances described enable a sufficiently high reflectivity of the optical data medium in the unrecorded state and sufficiently high absorption for the thermal degradation of the information layer during illumination at a point with focused blue light, in particular laser light, preferably having a light wavelength in the range from 360 to 460 nm. The contrast between recorded and unrecorded parts on the data medium is realized through the change in reflectivity in terms of the amplitude as well as the phase of the incident light as a result of the changed optical properties of the information layer after the recording. In particular the light absorbing substances guarantees a well defined shape of the readout signal with a drop of the reflectivity in the recorded mark.

In other words, the optical data medium can preferably be recorded on and read using laser light having a wavelength of 360-460 nm.

The coating with the phthalocyanines is preferably effected by spin-coating, sputtering or vacuum vapour deposition. By vacuum vapour deposition or sputtering, it is possible to apply in particular the phthalocyanines which are insoluble in organic or aqueous media, preferably those of the formula (1) in which w, x, y and z each denote 0 an d M represents

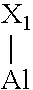

or represents

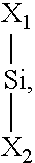

in which X₁ and X₂ have the abovementioned meaning.

In particular, the phthalocyanines which are soluble in organic or aqueous media are suitable for application also by spin-coating. The phthalocyanines can be mixed with one another or with other dyes having similar spectral properties. The information layer may contain additives, such as binders, wetting agents, stabilizers, diluents and sensitizers, and further components in addition to the phthalocyanines.

The merocyanine dyes and also the other dyes which are incorporated by reference (see above) are applied to the optical data carrier preferably by spin-coating or vacuum evaporation. Such dyes can be mixed with each other or with other dyes having similar spectral properties. In addition to these dyes the information layer can contain additives such as binders, wetting agents, stabilizers, diluents and sensitizers as well as other components.

The radiation cured resin is preferably an UV cured resin.

In a preferred embodiment the cover layer is formed by applying a radiation-curable resin as a top coat on the other layers, especially by spin-coating and then curing the coat by radiation, in particular UV-radiation.

Such radiation-curable resins preferably, liquid coating compositions are known and described, for example, in P. K. T. Oldring (Ed.), Chemistry & Technology of UV & EB Formulations For Coatings, Inks & Paints, Vol. 2, 1991, SITA Technology, London, pp. 31-235. Examples which can be mentioned are epoxy acrylates, urethane acrylates, polyester acrylates, acrylated polyacrylates, acrylated oils, silicone acrylates and amine-modified and non-modified polyether acrylates. In addition to the acrylates, methacrylates can be used in part or entirely. In addition to acrylates and methacrylates, polymeric products are also obtainable which contain vinyl, vinyl ether, propenyl, allyl, maleinyl, fumaryl, maleimide, dicyclopentadienyl and/or acrylamide groups as the polymerizable components. Acrylates and methacrylates are however preferred. Such resins are commercially obtainable and, depending on their composition, have varying viscosities preferably of from about 100 mPas to about 100,000 mPas. They are used singly or in the form of mixtures. Particularly preferred resins are those which are, as far as possible, highly transparent in the range from 750 to 300 nm, preferably 600 to 300 nm.

Examples of such resins are aliphatic urethane acrylates which can be obtained, for example, by reacting aliphatic and/or cycloaliphatic di- and/or polyisocyanates with hydroxyalkyl acrylates and di- and/or polyfunctional hydroxy compounds, and/or aliphatic polyester acrylates which can be obtained, for example, by reacting aliphatic di- and/or polycarboxylic acids or anhydrides thereof with di- and/or polyfunctional hydroxy compounds and acrylic acid. Aliphatic urethane acrylates are particularly preferred.

Particularly preferred resins are those which shrink only slightly in volume during curing. Hence a low double-bond density, low double bond functionality and a relatively high molecular weight is preferred. Preferred resins therefore have a double-bond density of below 3 mol/kg, a functionality of below 3, and particularly preferably below 2.5, and a molecular weight Mn of higher than 1,000, and particularly preferably higher than 3,000 g/mol.

In order to reduce the viscosities of the abovementioned products, so-called reactive thinners are normally used which (co)polymerize during curing with high energy radiation. Such reactive thinners are described, for example, in P. K. T. Oldring (Ed.), Chemistry & Technology of UV & EB Formulations For Coatings, Inks & Paints, Vol. 2, 1991, SITA Technology, London, pp. ²37-285. Examples which may be mentioned are the esters of acrylic acid or methacrylic acid, and preferably of the acrylic acids of the following alcohols. Monohydric alcohols are the isomeric butanols, pentanols, hexanols, heptanols, octanols, nonanols and decanols, as well as cycloaliphatic alcohols, such as isoborneol, cyclohexanol and alkylated cyclohexanols, dicyclopentanol, arylaliphatic alcohols such as phenoxyethanol and nonylphenyl ethanol, as well as tetrahydrofurfuryl alcohols. Alkoxylated derivatives of these alcohols can also be used. Dihydric alcohols are for example alcohols such as ethylene glycol, 1,2-propanediol, 1,3-propanediol, diethylene glycol, dipropylene glycol, the isomeric butanediols, neopentyl glycol, 1,6-hexanediol, 2-ethylhexanediol and tripropylene glycol or alkoxylated derivatives of these alcohols. Preferred dihydric alcohols are 1,6-hexanediol, dipropylene glycol and tripropylene glycol. Trihydric alcohols are glycerol or trimethylolpropane or alkoxylated derivatives thereof Aliphatic reactive thinners which are transparent at higher than 350 nm are preferred. Examples are hexanediol diacrylate, the isomeric butanediol dimethacrylates and isobornyl acrylate and methacrylate.

If curing is carried out by UV or visible light, photoinitiators are preferably added to the coating. Photoinitiators are known, commercially marketed compounds, differentiation being made between unimolecular (type 1) and bimolecular (type II) initiators. Suitable (type I) systems are aromatic ketone compounds, such as for example benzophenones in combination with tertiary amines, alkylbenzophenones, 4,4′-bis(dimethylamino)benzophenone (Michler's ketone), anthrone and halogenated benzophenones or mixtures of the aforementioned types. Also suitable are (type II) initiators such as benzoin and derivatives thereof, benzil ketals, acylphosphine oxides, such as for example 2,4,6-trimethyl-benzoyl-diphenylphosphine oxide, bisacyl-phosphine oxides, phenyl glyoxylic acid ester, camphorquinone, α-aminoalkyl-phenones, α,α-dialkoxyacetophenones and α-hydroxyalkylphenones.

The photoinitiators are preferably used in quantities of between 0.1 and 10% by weight, preferably 0.1 to 5% by weight, based on the weight of the lacquer binder, and can be used as single substances or, due to frequent advantageous synergistic effects, also in combination with each other.

Radiation curing is carried out by exposure to high energy radiation, i.e. UV radiation or daylight, such as for example light of a wavelength of 170 to 700 nm, or by irradiation with high energy electrons (electron radiation at 150 to 300 keV).

If electron beams are used instead of UV radiation, a photoinitiator is not required. As is known to those skilled in the art, electron radiation is produced by means of thermionic emission and accelerated via a potential difference. The high energy electrons then penetrate a titanium foil and are directed onto the binders to be cured. The general principles of electron radiation curing are described in detail in “Chermistry & Technology of TV & EB Formulations for Coatings, Inks & Paints”, Vol. 1, P K T Oldring (Ed.), SITA Technology, London, England, pp. 101-157, 1991.

The radiation sources used for light or UV light are for example high or medium pressure mercury vapour lamps, it being possible for the mercury vapour to be modified by doping with other elements such as gallium or iron. Lasers, pulsed lamps (known as UV flashlight emitters), halogen lamps or excimer radiators can also be used. The radiators can be equipped with filters which prevent the exit of one portion of the emitted radiator spectrum. It is for example possible, for reasons of industrial hygiene, to filter out radiation in the UV-C or UV-C and UV-B regions.

The radiators can be fitted in a stationary fashion so that the product to be irradiated is transported past the radiation source by means of a mechanical device, or the radiators can be movable and the product to be irradiated does not change its position during curing. The radiation dose usually sufficient for crosslinking during UV curing is in the range from 80 to 5,000 mJ/cm².

The irradiation can optionally also be carried out with the exclusion of oxygen, such as for example under an inert gas atmosphere or an oxygen-reduced atmosphere. Suitable inert gases are preferably nitrogen, carbon dioxide, rare gases or combustion gases. In addition, irradiation can be carried out by covering the coating with media transparent to the radiation. Examples of the latter are for example plastic films, glass or liquids such as water.

Depending on the radiation dose and the curing conditions, the type and concentration of the initiator possibly used must be varied in a manner known to those skilled in the art.

Particularly preferably, mercury high-pressure radiators in stationary units are employed. Photoinitiators are then used in concentrations of 0.1 to 10% by weight, preferably 0.2 to 3.0% by weight, based on the solids content of the coating. For the curing of these coatings a dosage of 200 to 3,000 mJ/cm², measured in the wavelength region of 200 to 600 nm, is preferably used.

The UV resin cover preferably posseses a high transparency at the wavelength of 360-460 nm, most preferably its transmittance exceeds 90%.

The optical data store may carry further layers, such as metal layers, dielectric layers, barrier layers, and protective layers, in addition to the information layer. Metal and dielectric and/or barrier layers serve, inter alia, for adjusting the reflectivity and the heat balance. Metals may be gold, silver, aluminium, alloys, etc., depending on the laser wavelength. Dielectric layers are, for example, silica and silicon nitride. Barrier layers can be comprised of dielectric layers or metal layers.

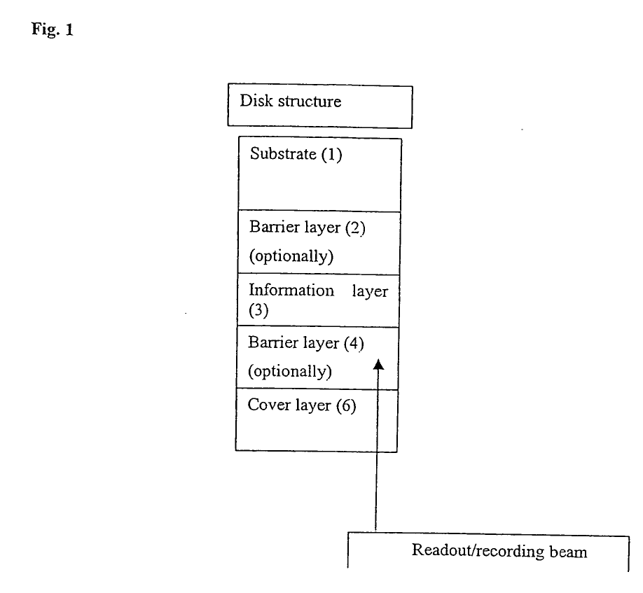

As shown in FIG. 1 the optical data store preferably contains a substrate (1), optionally a barrier layer (2), an information layer (3), optionally a further barrier layer (4) and a cover layer (6).

Preferably, the structure of the optical data medium can:

contain a preferably transparent substrate (1) on the surface of which at least one information layer (3) which can be recorded on using light, optionally a barrier layer (4) and a covering layer (6) have been applied.

contain a preferably transparent substrate (1) on the surface of which optionally a barrier layer (2), at least one information layer (3) which can be recorded on using light and a transparent covering layer (6) have been applied.

contain a preferably transparent substrate (1) on the surface of which optionally a barrier layer (2), at least one information layer (3) which can be recorded on using light, optionally a barrier layer (4), and a transparent covering layer (6) have been applied.

contain a preferably transparent substrate (1) on the surface of at least one information layer (3) which can be recorded on using light, and a transparent covering layer (6) have been applied.

The invention furthermore relates to optical data media according to the invention which can be recorded on using blue light, in particular laser light, particularly preferably laser light having a wavelength of 360-460 nm.

The following Examples illustrate the subject of the invention.

The invention furthermore relates to optical data media according to the invention which can be recorded on using blue light, in particular laser light, particularly preferably laser light having a wavelength of 360-460 nm.

The following Examples illustrate the subject of the invention.

### EXAMPLES

### Example 1

### Radiation-Curable Resin and its Application

Surface Coating

100 parts by weight of Roskydal® UA VP LS 2308 (an aliphatic urethane acrylate in an 80% concentration in hexanediol diacrylate, based on a hexamethylene diiso-cyanate trimer having a viscosity of 34 pa.s at 23° C. from Bayer A G, Leverkusen, Germany), 40 parts by weight of isobornyl acrylate (IBOA from UCB GmbH, Kerpen, Germany), 3 parts by weight of Irgacure® 184 (alpha-hydroxyacetophenone, a Norrish Type I Photoinitiator from Ciba Spezialitäitenchemie GmbH, Lampertheim, Germany) and 0.9 parts by weight of Byk® 306 (a levelling additive from Byk-Chemie GmbH, Wesel, Germany) are mixed intimately with each other and adjusted with butyl acetate to a dynamic viscosity of 500 mPa.s at 23° C.

Application: spin-coating conditions will be referred to in the respective examples

Curing: After flashing off the solvent (for 60 mins at room temperature or 30 mins at 60° C.) the coatings are cured by irradiation with a mercuric high pressure radiator (of Type CK, 120 W/cm length of the lamp, from IST in Nürtingen, Germany).

### Example 2

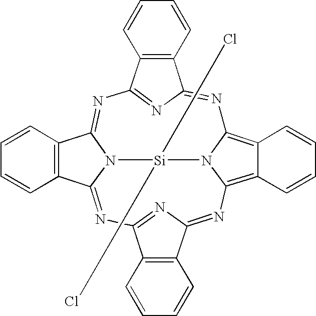

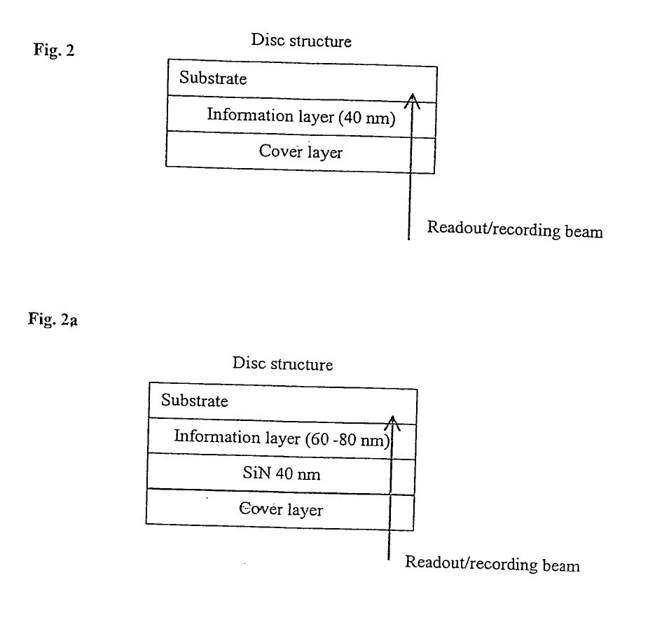

The dye dichloro-silicon-phthalocyanine (SiCl₂Pc) was applied for the information layer. The disc structure employed was as shown in FIG. 2.

The polycarbonate substrate was molded by injection method to form a groove structure of 0.32 μm pitch and the depth of 20 nm. Directly on top of the grooved surface the information layer of 40 nm was coated by vacuum vapor deposition method of the dye. A UV curable resin, according to example 1, was then applied by spin coating at 800 rmp rotation speed and cured by UV-light on the incident beam side of the medium to form the cover layer. Total thickness of the cured cover layer was set as 100 μm. Other UV-curable resins can be used in the same way.

The parameters of readout/recording setup was as follows (please confirm by Sony):

Wavelength of the laser=405 nm

Numerical aperture of the objective lens=0.85, two element lens

Readout laser power=0.40 mW

Writing laser power=7.0 mW

Line velocity of the disc rotation=5.28 m/s

Writing mark and space length=0.64 μm, periodic

Pulse strategy=7 pulses with 50% duty inside one mark.

The recording was performed On Groove.

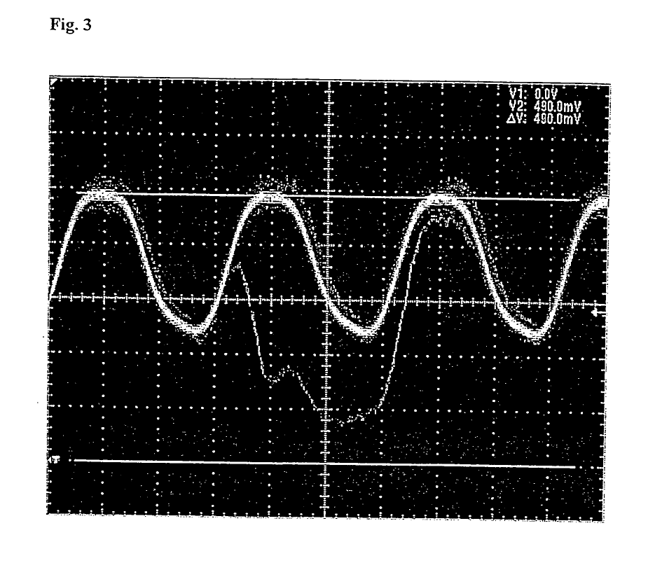

The result shows that the sharp edged rectangular waveform was recorded in this media with very low noise and high modulation ratio (FIG. 3). The carrier-to-noise ratio was 59.3 dB at 30 kHz RBW.

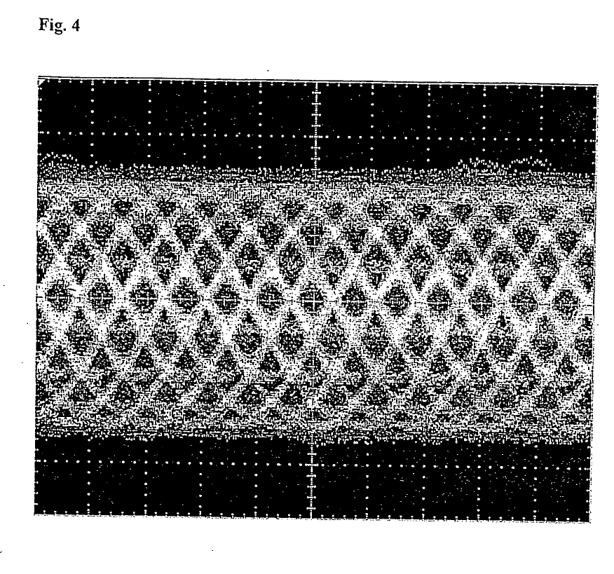

According to its high performance of the recording and readout stability, this media showed excessively high potential for the high density recording. A random pattern recording with (1,7) RLL modulation was preformed with the smallest mark length of 0.16 μm. The data capacity on a single side 12 cm diameter disc will correlate to 23.3 GB. A clear eye pattern was obtained through a conventional equalizer as shown in the FIG. 4, with its jitter level of 10% including cross-talk.

In a similar way the dyes of example 3-23 can be used.

### Examples 3-23

(MeX₁X₂)PcR³R⁴R⁵R⁶

| Nr. | Me | X₁ | X₂ | R³ | R⁴ | R⁵ | R⁶ |
|---|---|---|---|---|---|---|---|
| 3 | Al | Cl | — | — | — | — | — |
| 3a | Si | O—C₆H₅ | — | — | — | — | — |
| 4 | Al | O—C₆H₅ | — | — | — | — | — |
| 5 | Zn | — | — | — | — | — | — |
| 6 | V | ═O | — | — | — | — | — |
| 7 | Ga | Cl | — | — | — | — | — |
| 8 | In | Cl | — | — | — | — | — |
| 9 | Ge | Cl | Cl | — | — | — | — |
| 9a | Ge | Br | Br | — | — | — | — |
| 10 | Si | OCH₂CH₃ | OCH₂CH₃ | — | — | — | — |
| 11 | Si | CH₃ | Cl | — | — | — | — |
| 12 | Si | Phenyl | Cl | — | — | — | — |
| 13 | Si | CH₃ | OCH₂CH₃ | — | — | — | — |
| 14 | Si | Osi(CH₃)₃ | Osi(CH₃)₃ | — | — | — | — |
| 15 | Si | Cl | Cl | C(CH₃)₃ | C(CH₃)₃ | — | — |
| 16 | Si | Cl | Cl | C(CH₃)₃ | C(CH₃)₃ | C(CH₃)₃ | C(CH₃)₃ |
| 17 | Al | Cl | — | C(CH₃)₃ | C(CH₃)₃ | C(CH₃)₃ | C(CH₃)₃ |
| 18 | Al | OH | — | — | — | — | — |
| 19 | Al | Cl | — | Si(CH₃)₃ | Si(CH₃)₃ | Si(CH₃)₃ | Si(CH₃)₃ |
| 20 | Ti | OSi(CH₃)₃ | OSi(CH₃)₃ | — | — | — | — |
| 21 | Sn | OSi(CH₃)₃ | OSi(CH₃)₃ | — | — | — | — |
| 21a | Sn | Cl | Cl | — | — | — | — |
| 22 | Zr | OSi(CH₃)₃ | OSi(CH₃)₃ | — | — | — | — |
| 23 | Ru | OCH₂CH₃ | OCH₂CH₃ | — | — | — | — |

### Example 24

2.1 g of 1-butyl-3-cyano-4-methyl-6-hydroxy-2-pyridone and 2.0 g of 1,3,3-trime-thylindole-2-methylene-ω-aldehyde were stirred into 5 ml of acetic anhydride for 2 hours at 90° C. After cooling, the mixture was discharged onto 100 ml of iced water, filtered off with suction and the residue washed with water. It was then stirred into 20 ml of water/methanol 3:1, filtered off with suction and dried. 3.3 g (85% of theory) of a red powder of the formula

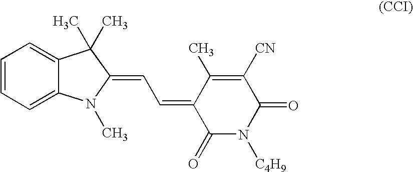

were obtained.

M.p.=249-251° C.

UV (dioxane): λₘₐₓ=520 mn

UV (DMF): λₘₐₓ=522 nm

ε=113100,l/mol cm

Δλ=2 nm

λ_{1/2}-λ_{1/10} (longwave slope)=12 nm

Solubility: >2% in TFP (2,2,3,3-tetrafluoropropanol).

### Example 25

Following the same procedure 2.6 g (79% of theory) of a red powder of the formula

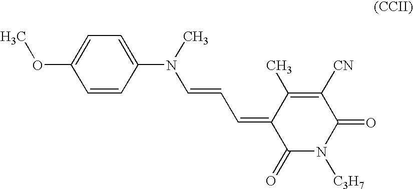

were obtained using 1.7 g of 1-propyl-3-cyano-4-methyl-6-hydroxy-2-pyridone and 1.7 g of N-methyl-N-(4-methoxyphenyl)-acrolein.

M.p.=206-216° C.

UV (dioxane): λₘₐₓ=482 nm

UV (DMF): λₘₐₓ=477 nm

ε=73013 l/mol cm

Δλ=5 nm

λ_{1/2}-λ_{1/10} (shortwave slope)=33 nm

Solubility: >2% in TFP.

### Example 26

2.03 g of 3-pyridinio4-methyl-6-hydroxy-pyridone chloride and 2.0 g of 1,3,3-trime-thylindole-2-methylene-ω-aldehyde were stirred into 10 ml of acetic anhydride for 2 hours at 90° C. After cooling, the mixture was discharged onto 200 ml of water. 2.8 g of sodium tetrafluoroborate were added to the orange solution. After stirring the mixture overnight it was filtered off with suction and the residue was washed with 20 ml of water and dried. 3.3 g (74% of theory) of a reddish orange powder of the formula

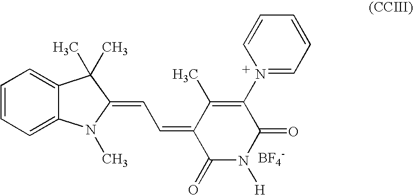

were obtained.

M.p. >300° C.

UV (methanol): λₘₐₓ=513 nm

ε=86510 l/mol cm

λ_{1/2}-λ_{1/10} (shortwave slope)=38 nm

Solubility: >2% in TFP.

### Example27

0.7 g of 5-dimethylaminofuran-2-carbaldehyde and 1.5 g of N-methyl-N′-dodecyl-barbituric acid were stirred into 15 ml of acetic anhydride for 30 mins. at 90° C. After cooling, the mixture was discharged onto 100 ml of iced water, filtered off with suction and the residue washed with water. 1.7 g (79% of theory) of an orange powder of the formula

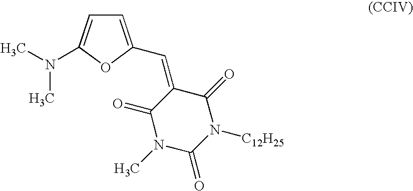

was obtained.

M.p. 118-120° C.

UV (dioxane): λₘₐₓ=483 nm

ε=53360 l/mol cm

λ_{1/2}-λ_{1/10} (shortwave slope)=32 nm

Solubility: >1% in benzyl alcohol.

Other examples according to the invention are summarized in the following tables:

TABLE 1
(Formula (VI)

| Ex. | 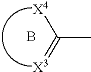 | Y¹ | ═CX¹X² | λₘₐₓ¹⁾/ nm | ε/ l/mol cm | λ_{1/2}-λ_{1/10}/ nm | Δλ²⁾/ nm |
|---|---|---|---|---|---|---|---|
| 28 | 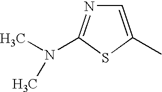 | C—CN | ═C(CN)₂ | 470 | 40990 | 32³⁾ | 16 |
| 29 | ” | CH | 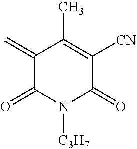 | 502 | 62860 | 33³⁾ | |
| 30 | 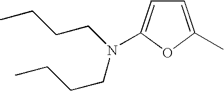 | CH | ” | 539 | 146480 | 18⁴⁾ | 1.5 |
| 31 | ” | CH | 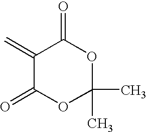 | 472 | 70880 | 32³⁾ | 5 |
| 32 | ” | CH | 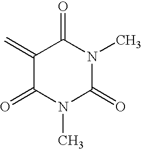 | 490 (DMF) | | | |
| 33 | ” | CH | 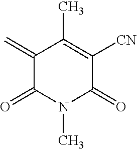 | 539 | 106640 | | |
| 34 | 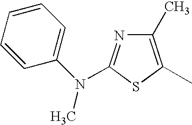 | CH | 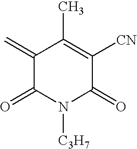 | | | | |
| 35 | 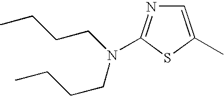 | CH | 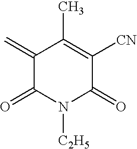 | 508 | 78400 | | |
| 36 | 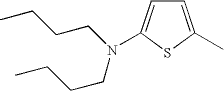 | CH | 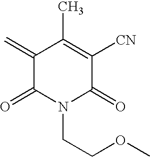 | 536 | 112260 | | |
| 37 | 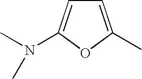 | CH | 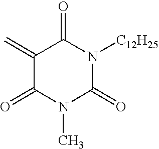 | 483 | 53360 | | |
| 38 | ” | CH | 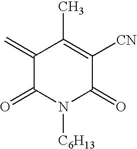 | 535 | 128960 | | 1.3 |
| 39 | 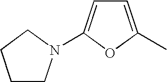 | CH | 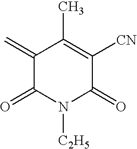 | 536 (DMF) | 115603 | | 2 |
| 40 | 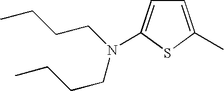 | CH | 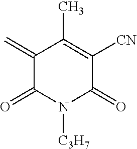 | 535 | 112260 | 13⁴⁾ | |
| 41 | 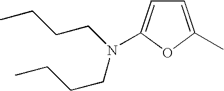 | CH | 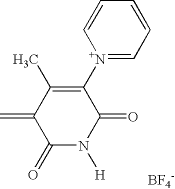 | | | | |
| 42 | 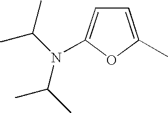 | CH | 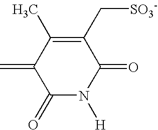 | | | | |
| 43 | 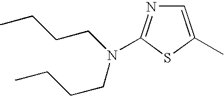 | N | 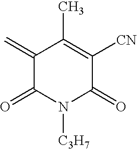 | | | | |
| 44 | ” | C—CN | ═C(CN)₂ | | | | |
| 45 | 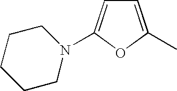 | CH | 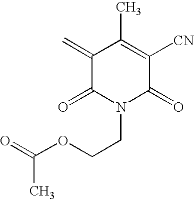 | | | | |
| 46 | 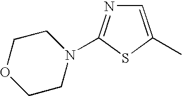 | CH | 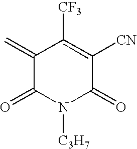 | | | | |
| 47 | 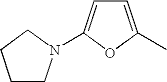 | CH | 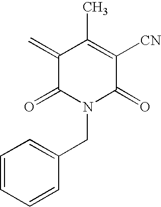 | | | | |
| 48 | 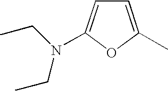 | CH | 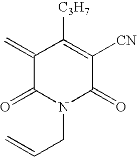 | | | | |
| 49 | ” | CH | 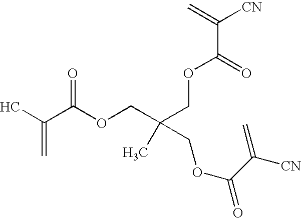 | 455 | | | |
| 50 | 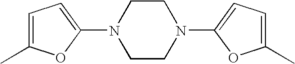 | CH | 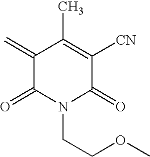 | 538 | | | |
| 51 | 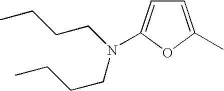 | CH | 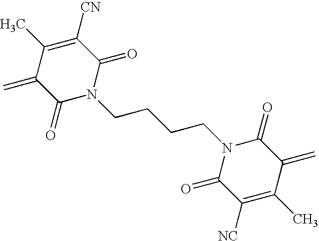 | 537 | 132860 | | |
| 52 | 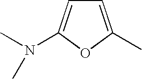 | CH | 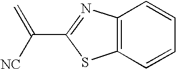 | 490 | 35000 | 40³⁾ | 23 |
| 53 | 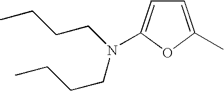 | CH | 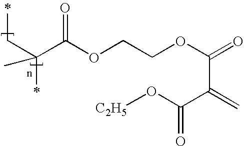 | 431 (DMF) | | | |
| 54 | ” | CH | 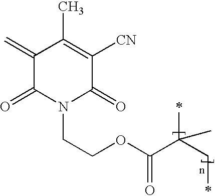 | 536 (DMF) | | | |
| 55 | 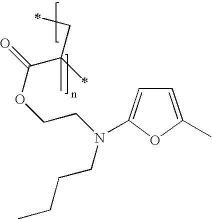 | CH | 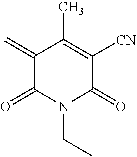 | 536 (DMF) | | | |

¹⁾in dioxane, unless indicated otherwise
²⁾= |λ_{DMF}-λ_{dioxane}|
³⁾on the shortwave slope
⁴⁾on the longwave slope

TABLE 2
(Formula (VII)

| Ex. | 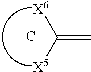 | Y²-Y¹ | ═CX¹X² | λₘₐₓ¹⁾/ nm | ε/ l/mol cm | λ_{1/2}-λ_{1/10}/ nm | Δλ²⁾/ nm |
|---|---|---|---|---|---|---|---|
| 56 | 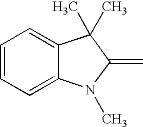 | CH-C(CN) | ═C(CN)₂ | 499 | 46470 | 36³⁾ | 5 |
| 57 | ” | CH-CH | 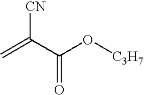 | 429 | 60390 | 30³⁾ | 7 |
| 58 | ” | CH-CH | 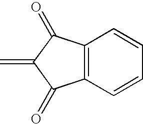 | 487 | 102220 | 35³⁾ | 6 |
| 59 | ” | CH-CH | 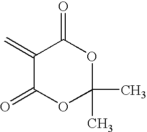 | 448 | 76260 | 27³⁾ | 2 |
| 60 | ” | CH-CH | 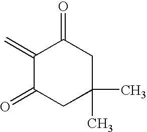 | 469 | 76130 | 28³⁾ | 3 |
| 61 | ” | CH-CH | 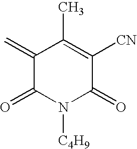 | 520 | 113100 | 12⁴⁾ | 2 |
| 62 | 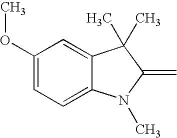 | CH-C(CN) | ═C(CN)₂ | 511 | 31345 | 36³⁾ | 6 |
| 63 | 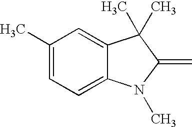 | CH-C(CN) | ” | 503 | 41530 | 36³⁾ | 6 |
| 64 | 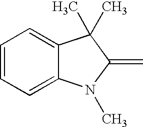 | CH-CH | 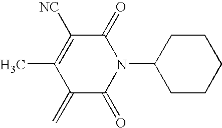 | 519 | 55910 | 11⁴⁾ | |
| 65 | 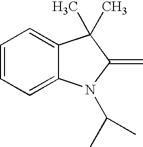 | CH—CH | 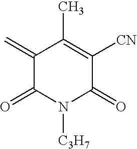 | | | | |
| 66 | ” | CH-CH | 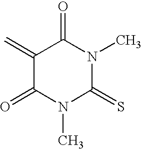 | 486 | 115091 | | |
| 67 | 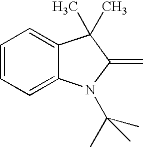 | CH-CH | 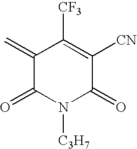 | | | | |
| 68 | 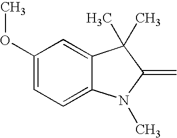 | CH-CH | 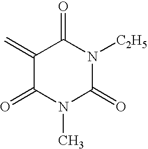 | | | | |
| 69 | ” | CH-CH | 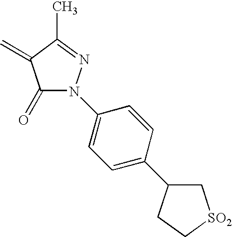 | 473 | 47640 | | |
| 70 | 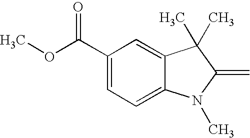 | CH-CH | 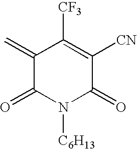 | | | | |
| 71 | ” | CH-CH | 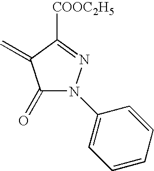 | 496 | 62720 | | |
| 72 | ” | CH-CH | 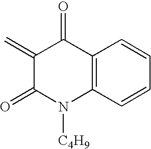 | 500 | 110332 | | |
| 73 | 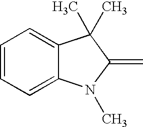 | CH-CH | 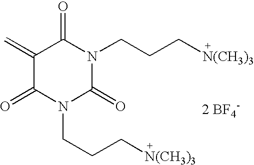 | | | | |
| 74 | 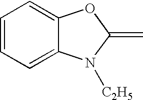 | CH—CH | 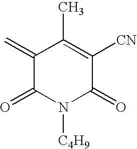 | 490 (DMF) | 109380 | | 5 |
| 75 | 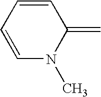 | CH—CH | 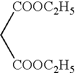 | 450 | | | |
| 76 | 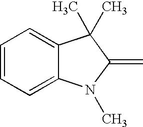 | CH—CH | 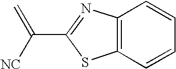 | 462 | 57230 | 34³⁾ | |
| 77 | 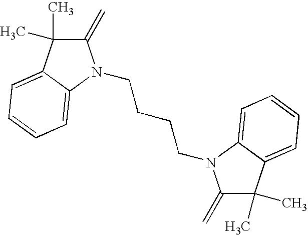 | CH—C(CN) | ═C(CN)₂ | 500 | | | |
| 78 | 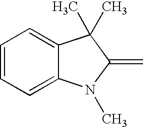 | CH-CH | 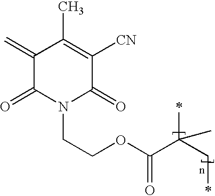 | 521 (DMF) | | | |

¹⁾in dioxane, unless indicated otherwise
²⁾= |λ_{DMF}-λ_{dioxane}|
³⁾on the shortwave slope
⁴⁾on the longwave slope

TABLE 3
(Formula (VIII)

| Ex. | NR⁹R¹⁰ | Y¹ | ═CX¹X² | λₘₐₓ¹⁾/ nm | ε/ l/mol cm | λ_{1/2}-λ_{1/10}/ nm | Δλ²⁾/ nm |
|---|---|---|---|---|---|---|---|
| 79 | 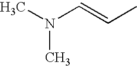 | CH | 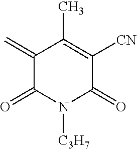 | 462 | 77180 | 28³⁾ | 8 |
| 80 | ” | CH | 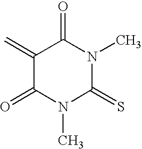 | | | | |
| 81 | ” | CH | 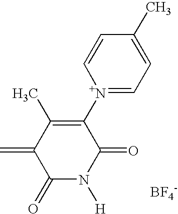 | | | | |
| 82 | ” | CH | 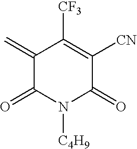 | 918 (DMF) | 89100 | | |
| 83 | 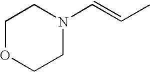 | CH | 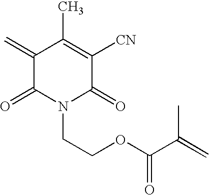 | 458 | 89800 | 28³⁾ | |
| 84 | 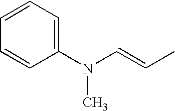 | CH | 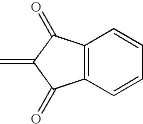 | 447 | 84070 | | |
| 85 | ” | CH | 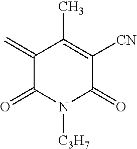 | 480 | 79685 | | 1.3 |
| 86 | 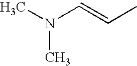 | CH | 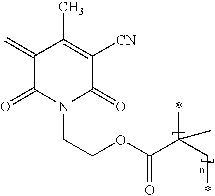 | 453 (DMF) | | | |

¹⁾in dioxane, unless indicated otherwise
²⁾= |λ_{DMF}-λ_{dioxane}|
³⁾on the shortwave slope
⁴⁾on the longwave slope

### Example 87

The dye shown above in example 76, which has the formula

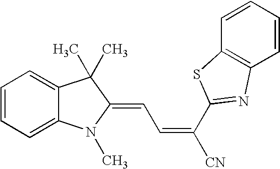

was applied for the information layer. The disc structure employed was as shown in FIG. 2a.

The polycarbonate substrate was molded by injection method to form a land/groove structure of 0.64 μm pitch and the depth of 40 nm. Directly on top of the grooved surface the information layer was coated by spin-coating method. The parameters for spin-coating were as follows.

Solvent: Tetrafluoropropanol (TFP)

Solution: 1.0 wt.%

Disc rotation speed for coating the solvent: 220 rpm, 12 seconds.

Disc rotation speed for spin off and drying: 1200 rpm, 30 seconds

Thickness of the dye layer in groove and on land was 80 nm and 60 nm respectively. To prevent the information layer to diffuse into the cover layer, the information layer was covered with a SiN buffer layer of 40 nm thickness by RF reactive sputtering method. A UV curable resin, according to example 1, was then applied by spin coating at 800 rmp rotation speed and cured by UV-light on the incident beam side of the medium to form the cover layer. Total thickness of the cured cover layer was set as 100 μm. Other UV-curable resins can be used in the same way.

The parameters of readout/recording set-up were as follows:

Wavelength of the laser=405 nm

Numerical aperture of the objective lens=0.85, two element lens

Readout laser power=0.30 mW

Writing laser power=6.0 mW

Line velocity of the disc rotation=5.72 m/s

Writing mark and space length=0.69 μm, periodic

Pulse strategy=7 pulses with 50% duty inside one mark

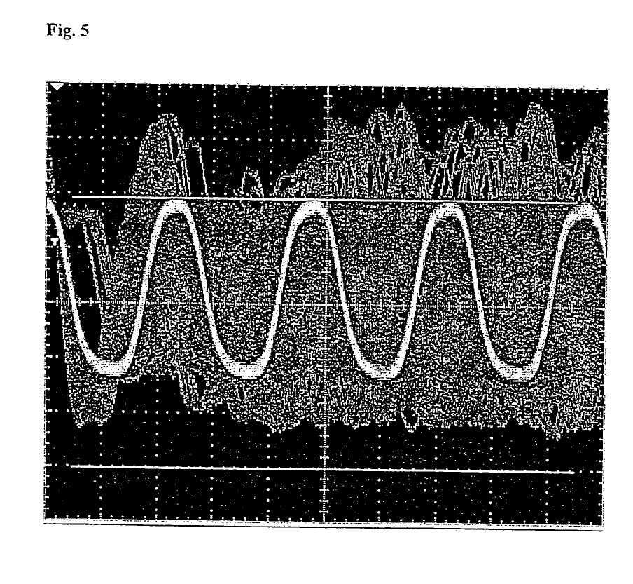

As a result, after recording on a groove track, a clear noiseless waveform was obtained as shown in the FIG. 5. The carrier-to-noise ratio (C/N) measurement was performed using Takeda Riken TR4171, resulting in 62.8 dB at 30 kHz resolution band width (RBW). These high C/N prove its high performance for high density recording, since this media was recordable on both land/groove, which lead to practically a doubled track pitch, namely 0.32 μm. Also, point to be noted is that the modulation ratio (reflectivity from the marks/R_{Init}) was reaching almost 66%. With such huge modulation ratio, this media presents an ideal signal quality and ultimate carrier level.

1. Optical data medium containing an optionally transparent substrate which is optionally coated with one or more barrier layers and on the surface of which an information layer which can be recorded on using light, optionally one or more barrier layers, and a cover layer containing a radiation-cured resin, have been applied, which data medium can be recorded on and read from using focused blue light through the cover layer on the information layer, optionally the blue light is laser light with the wavelength between 360 nm and 460 nm, the information layer containing a light-absorbing compound characterized in that at least one dye is used as the light-absorbing compound wherein the cover layer does have a total thickness of 10 μm to 177 μm and the numerical aperture NA of the focusing objective lens setup is greater or equal 0.8.

2. The optical data medium according to claim 1, wherein the cover layer is a UV-cured resin.

3. The optical data medium according to claim 1, wherein the cover layer has a transmittance higher than 90% at a wavelength of 360 to 460 nm.

4. The optical data medium according to claim 1, wherein the dye used as the light absorbing compound is a phthalocyanine or a naphthalocyanine, where in both cases the aromatic rings also may be heterocycles.

5. The optical data medium according to claim 1, wherein the one or more barrier layers on top of the information layer at least contain one dielectric layer.

6. The optical data medium according to claim 1, wherein the one or more barrier layers contain a dielectric layer directly on top of the information layer and a cover layer containing a radiation-cured resin on the dielectric layer.

7. The optical data medium according to claim 1, wherein the cover layer contains an UV-cured resin on the basis of an aliphatic urethane acrylate curable resin.

8. The optical data medium according to claim 1, characterized in that the dye corresponds to the formula (I)
MPc[R³]_{w}[R⁴]ₓ[R⁵]_{y}[R⁶]_{z} (I),
in which
Pc represents a phthalocyanine or a naphthalocyanine, where in both cases the aromatic rings also may be heterocycles,
M represents two independent H atoms, represents a divalent metal atom or represents a trivalent axially monosubstituted metal atom of the formula (Ia) 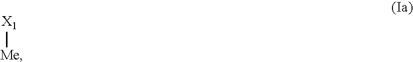
or represents a tetravalent axially disubstituted metal atom of the formula (Ib) 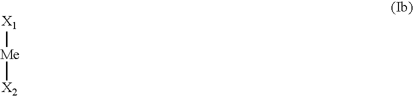
or represents a trivalent axially monosubstituted and axially monocoordinated metal atom of the formula (Ic) 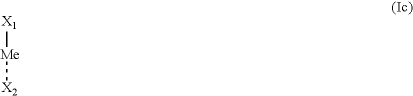
where, in the case of a charged ligand or substituent X₁ or X₂, the charge being compensated by an opposite ion and
the radicals R³ to R⁶ corresponding to substituents of the phthalo-cyanine,
X¹ and X², independently of one another, represent halogen, hydroxyl, oxygen, cyano, thiocyanato, cyanato, alkenyl, alkinyl, arylthio, dialkylamino, alkyl, alkoxy, acyloxy, alkylthio, aryl, aryloxy, —O—SO₂R⁸, O—PR¹⁰R¹¹, —O—P(O)R¹²R¹³, —O—SiR¹⁴R¹⁵R¹⁶, NH₂, alkylamino and the radical of a heterocyclic amine,
R³, R⁴, R⁵ and R⁶, independently of one another, represent halogen, cyano, nitro, alkyl, aryl, alkylamino, dialkylamino, alkoxy, alkylthio, aryloxy, arylthio, SO₃H, SO₂NR¹R², CO₂R⁹, CONR¹R², NH—COR⁷ or a radical of the formula —(B)ₘ-D, in which
B denotes a bridge member from the group consisting of a direct bond, CH₂, CO, CH(alkyl), C(alkyl)₂, NH, S, O or —CH═CH—, (B)ₘ denoting a chemically reasonable sequence of bridge members B with m=1 to 10, m preferably being 1, 2, 3 or 4,
D represents the monovalent radical of a redox system of the formula 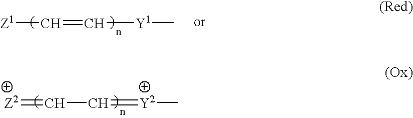
or represents a metallocenyl radical or metallocenylcarbonyl radical, titanium, manganese, iron, ruthenium or osmium being suitable as the metal centre,
Z¹ and Z², independently of one another, represent NR′R″, OR″ or SR″,
Y¹ represents NR′, O or S, Y² represents NR′,
n represents 1 to 10 and
R′ and R″, independently of one another, represent hydrogen, alkyl, cycloalkyl, aryl or hetaryl, or form a direct bond or a bridge to one of the C atoms of the 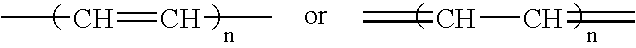
chain,
w, x, y and z, independently of one another, represent 0 to 4 and w+x+y+z ≦16,
R¹ and R², independently of one another, represent alkyl, hydroxyalkyl or aryl or R¹ and R², together with the N atom to which they are bonded, form a heterocyclic 5-, 6- or 7-membered ring, optionally with participation of further hetero atoms, in particular from the group consisting of O, N and S, NR¹ R² representing in particular pyrrolidino, piperidino or morpholino,
R⁷ and R¹⁶, independently of one another, represent alkyl, aryl, hetaryl or hydrogen.

9. The optical data media according to claim 8, characterized in that
M represents two independent H atoms or represents a divalent metal atom selected from the group consisting of Cu, Ni, Zn, Pd, Pt, Fe, Mn, Mg, Co, Ru, Ti, Be, Ca, Ba, Cd, Hg, Pb and Sn or represents a trivalent axially monosubstituted metal atom of the formula (Ia) in which Me represents Al, Ga, Ti, In, Fe or Mn or represents a tetravalent metal atom of the formula (Ib) in which Me represents Si, Ge, Sn, Zn, Cr, Ti, Co or V.

10. The optical data media according to claim 6, characterized in that
M represents a radical of the Formula (Ia) or (Ib), in which Me represents Al or Si,
X¹ and X₂ each are selected from the group consisting of halogen, chlorine, aryloxy, phenoxy, or alkoxy, and methoxy, and
w, x, y and z each represent 0.

11. The optical data medium according to claim 1, wherein the light absorbing compound is a merocyanine.

12. The optical data medium according to claim 1, wherein the light absorbing compound corresponds to formula (1) 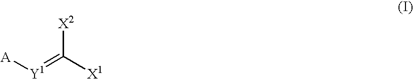
is preferred, wherein
A represents a radical of the formula 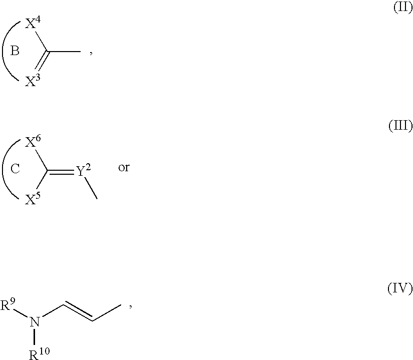
X¹ represents CN, CO—R¹, COO—R², CONHR³ or CONR³R⁴,
X² represents hydrogen, C₁- to C₆-alkyl, C₆- to C₁₀-aryl, a five- or six-membered heterocyclic radical, CN, CO—R¹, COO—R², CONHR³ or CONR³R⁴ or
CX¹X² represents a ring of the formulae 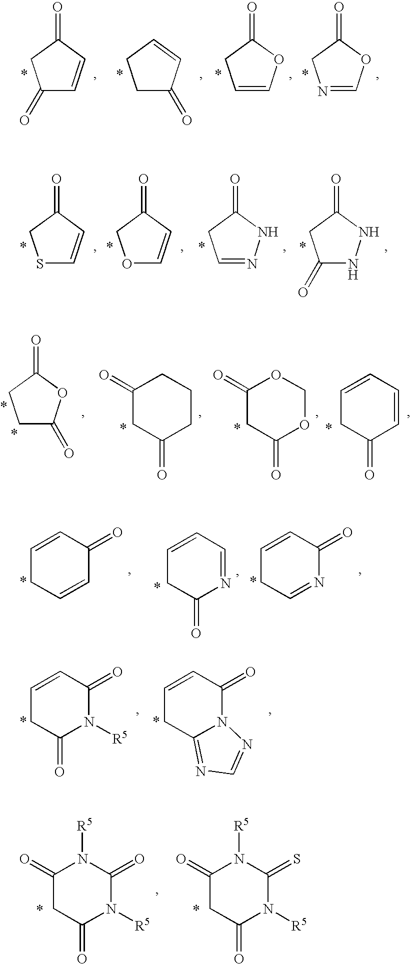
which can be benzo- or naphthafused and/or substituted by non-ionic or ionic radicals and wherein the asterisk (*) indicates the ring atom from which the double bond emanates,
X³ represents N or CH,
X⁴ represents O, S, N, N—R⁶ or CH, wherein X³ and X⁴ do not simultaneously represent CH,
X⁵ represents O, S or N—R⁶
X⁶ represents O, S, N, N—R, CH or CH₂,
the ring B of the formula (II) 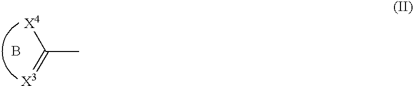
together with X⁴, X³ and the C atom bound therebetween
and the ring C of the formula (V) 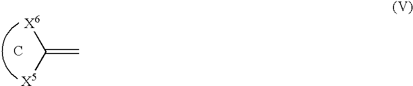
together with X⁵, X⁶ and the C atom bound therebetween
independently of one another represent a five- or six-membered aromatic or quasiaromatic heterocyclic ring which can contain 1 to 4 hetero atoms and/or can be benzo- or naphtha-fused and/or substituted by non-ionic or ionic radicals,
Y¹ represents N or C—R⁷,
Y² represents N or C—R⁸,
R¹ to R⁶ independently of one another represent hydrogen, C₁ to C₆-alkyl, C₃ to C₆-alkenyl, C₅ to C₇-cycloalkyl, C₆- to C₁₀-aryl or C₇ to C₁₅-aralkyl,
R⁷ and R⁸ independently of one another represent hydrogen, cyano or C₁ to C₆-alkyl,
R⁹ and R¹⁰ independently of one another represent C₁ to C₆-alkyl, C₆ to C₁₀-aryl or C⁷ to C₁₅-aralkyl or
NR⁹R¹⁰ represents a 5- or 6-membered saturated heterocyclic ring.

13. Process for the production of the optical data media according to claim 1, which is characterized in that a transparent substrate optionally already coated with a barrier layer is coated with the dye, optionally in combination with suitable binders and additives and optionally suitable solvents, and then is optionally provided with a barrier layer, further intermediate layers and a cover layer containing radiation-curable resin which is subsequently cured with radiation.

14. Process for the production of the optical data media according to claim 13, characterized in that the coating with the dye is affected by means of spin-coating, sputtering or vapor deposition.

15. Optical data media having a recordable information layer, obtainable by recording on optical data media according to claim 1 using blue light, optionally laser light, and optionally the laser light having a wavelength of 360-460 nm.
